(19) United States
(12) Patent Application Publication
(10) Pub. No.: US 2025/0360696 A1
(43) Pub. Date: Nov. 27, 2025

(54) MULTILAYER FILM AND PACKAGING MATERIAL USING SAME

(71) Applicant: Kuraray Co., Ltd., Okayama (JP)

(72) Inventors: Satoshi ISHIUCHI, Kurashiki-shi, Okayama (JP); Kentaro YOSHIDA, Kurashiki-shi, Okayama (JP)

(73) Assignee: Kuraray Co., Ltd., Okayama (JP)

(21) Appl. No.: 18/873,714

(22) PCT Filed: Jun. 23, 2023
(86) PCT No.: PCT/JP2023/023325

§ 371 Date: Dec. 10, 2024

(30) Foreign Application Priority Data
Jun. 24, 2022 (JP) 2022-101822

(51) Int. Cl. B32B 27/08; B32B 7/12; B32B 27/30; B32B 27/32

(52) U.S. Cl. CPC B32B 27/08; B32B 7/12; B32B 27/306; B32B 27/32; B32B 2250/04; B32B 2264/102; B32B 2307/31; B32B 2307/54; B32B 2307/72; B32B 2307/7244; B32B 2307/7376; B32B 2439/70

(57) ABSTRACT

The present disclosure provides a multilayer film with a layer (A) containing an EVOH; a layer (B) containing an adhesive resin (b); a layer (C) containing a polyethylene-based resin (c); and a layer (D) containing an ethylene-α-olefin copolymer resin (d).

### TECHNICAL FIELD

The present invention relates to a multilayer film and a multilayer structure that are excellent in barrier properties, mechanical properties, and recyclability, as well as a packaging material, a recycled composition, and a recycling method that use the same.

### BACKGROUND ART

Packaging materials for long term storage of foods are often expected to have gas barrier properties including oxygen barrier properties. Use of packaging materials with high gas barrier properties allows inhibition of food oxidative degradation and microorganism propagation due to oxygen permeation. As a layer to improve the gas barrier properties, foil of metal, such as aluminum, and inorganic vapor deposited layers including silicon oxide and aluminum oxide are widely used. Meanwhile, resin layers with gas barrier properties, such as vinyl alcohol-based polymers and polyvinylidene chloride, are also widely used. Such a vinyl alcohol-based polymer has characteristics that hydroxyl groups in the molecule are hydrogen bonded to each other for crystallization and an increase in the density to exhibit the gas barrier properties. Among all, ethylene-vinyl alcohol copolymers (hereinafter, may be abbreviated as “EVOHs”) are excellent in thermal stability and thus are suitable for melt molding, and with the development of the coextrusion technique, multilayer films having an EVOH layer as an intermediate layer are widely used as a packaging material with gas barrier properties.

In addition, in recent years, environmental issues and waste issues have triggered globally increased expectations for so-called post-consumer recycling (hereinafter, may be abbreviated simply as recycling), in which packaging materials consumed in the market are collected for resource recovery. The recycling process generally employs the steps of cutting collected packaging materials, separating and washing as needed, followed by melt mixing using an extruder. In this regard, packaging materials are expected to be composed of, if possible, a single material (mono-materialization), thereby making it possible to obtain highly purified and high quality resource recovered raw materials.

Patent Document 1 describes that a multilayer film including: a hard layer with a puncture strength of 40 N/mm or more and 150 N/mm or less; and (1) a resin composition layer having an EVOH with a melting point of 170° C. or more and an EVOH with a melting point of less than 170° C. or (2) a resin composition layer having a modified EVOH containing a modified group with a specific primary hydroxyl group is excellent in mechanical strength and thermoformability although not having a polyamide layer and is also excellent in recyclability because generation of hard spots and the like due to resin degradation (gelation) is inhibited while its collected material is melt molded.

### CITATION LIST

### Patent Literature

Patent Literature 1: WO 2020/071513 A1

### SUMMARY OF INVENTION

### Technical Problem

However, use as a packaging material for contents with a large weight tends to expect higher mechanical strength, and the multilayer film described in Patent Document 1 sometimes has insufficient mechanical strength. In addition, although an increase in the thickness of the multilayer film can improve the mechanical strength, the amount of resin to be used in packaging materials increases and thus efficient improvement in the mechanical strength is expected while the thickness is kept as low as possible. For example, when barrier films are used as packaging materials for foods such as soup, or liquids such as detergents, or as packaging materials for materials that solidify by absorbing moisture such as powders, permeation of moisture and the like has to be inhibited to maintain quality. However, the multilayer film described in Patent Document 1 sometimes has insufficient water vapor barrier properties.

The present invention has been made to solve the above problems, and it is an object thereof to provide a multilayer film and a multilayer structure that are excellent in barrier properties (oxygen barrier properties and water vapor barrier properties), mechanical properties, and recyclability as well as a packaging material using the same.

### Solution to Problem

According to the present invention, the above objects are achieved by providing:
[1] a multilayer film, comprising: a barrier layer (A) containing an ethylene-vinyl alcohol copolymer (a) (hereinafter, may be abbreviated as an “EVOH (a)”) as a main component, the copolymer (a) having an ethylene unit content from 20 to 50 mol % and a degree of saponification of 90 mol % or more; an adhesive layer (B) containing an adhesive resin (b) as a main component; a thermoplastic resin layer (C) containing a polyethylene-based resin (c) as a main component, the resin (c) having a density from 0.941 to 0.980 g/cm³; and a heat seal layer (D) containing an ethylene-α-olefin copolymer resin (d) as a main component, the resin (d) having a density from 0.880 to 0.920 g/cm³, wherein the multilayer film has the barrier layer (A) between at least a pair of the thermoplastic resin layer (C) and the heat seal layer (D) and has no layer containing a resin with a melting point of 200° C. or more as a main component and no metal layer with a thickness of 1 μm or more, and when a temperature is risen from −50° C. to 220° C. at 10° C./min (first temperature rise) and then lowered to −50° C. at 10° C./min and further risen to 220° C. at 10° C./min (second temperature rise) using a differential scanning calorimeter (DSC), a ratio (H1/H2) of a total heat of fusion (H1) from 0° C. to 150° C. during the first temperature rise to a total heat of fusion (H2) from 0° C. to 150° C. during the second temperature rise is from 0.75 to 1.01;
[2] the multilayer film according to [1], wherein one outermost layer is the thermoplastic resin layer (C) and another outermost layer is the heat seal layer (D);
[3] the multilayer film according to [1] or [2], comprising an adhesive layer (B1) between the barrier layer (A) and the thermoplastic resin layer (C), wherein the adhesive layer (B1) contains an adhesive resin (b1) as a main component and the resin (b1) has an acid value of 0.50 mg KOH/g or more and 2.50 mg KOH/g or less;
[4] the multilayer film according to any one of [1] through [3], wherein the polyethylene-based resin (c) and the ethylene-α-olefin copolymer resin (d) have respective MFRs (190° C., under a load of 2.16 kg) measured in accordance with JIS K7210 (2014) from 0.5 to 2.0 g/10 min;
[5] the multilayer film according to any one of [1] through [4], wherein the ethylene-α-olefin copolymer resin (d) is linear low-density polyethylene obtained by copolymerizing ethylene and an α-olefin with a carbon number of 6 or more;
[6] the multilayer film according to any one of [1] through [5], wherein the heat seal layer (D) contains from 100 to 7000 ppm of a higher fatty acid amide compound (e) with a melting point from 60° C. to 120° C.;
[7] the multilayer film according to any one of [1] through [6], wherein the heat seal layer (D) contains from 500 to 5000 ppm of inorganic oxide particles (f) with an average particle diameter from 1 to 30 μm and the inorganic oxide particles (f) are at least one selected from the group consisting of silicon oxide particles and metal oxide particles;
[8] the multilayer film according to any one of [1] through [7], wherein the barrier layer (A) contains from 10 to 200 ppm of polyvalent metal ions (g) that are at least one selected from the group consisting of magnesium ions, calcium ions, and zinc ions;
[9] the multilayer film according to any one of [1] through [8], wherein the barrier layer (A) contains from 10 to 400 ppm of alkali metal ions;
[10] the multilayer film according to any one of [1] through [9], wherein the ethylene-vinyl alcohol copolymer (a) contains an EVOH (a1) having an ethylene unit content of 22 mol % or more and less than 34 mol % and a degree of saponification of 99 mol % or more and an EVOH (a2) having an ethylene unit content of 34 mol % or more and less than 50 mol % and a degree of saponification of 99 mol % or more;
[11] the multilayer film according to any one of [1] through [10], wherein, when the temperature is risen from −50° C. to 220° C. at 10° C./min (the first temperature rise) and then lowered to −50° C. at 10° C./min and further risen to 220° C. at 10° C./min (the second temperature rise) using a differential scanning calorimeter (DSC), a ratio (H1/H2) of a total heat of fusion (H1) from 150° C. to 200° C. during the first temperature rise to a total heat of fusion (H2) from 150° C. to 200° C. during the second temperature rise is from 0.90 to 1.35;
[12] the multilayer film according to any one of [1] through [11], wherein a total thickness of all layers is 200 μm or less and a ratio of a thickness of the barrier layer (A) to the total thickness of all layers is 0.10 or less;
[13] the multilayer film according to any one of [1] through [12], wherein a total thickness of all layers is 200 μm or less and a ratio of a thickness of the thermoplastic resin layer (C) to the total thickness of all layers is 0.20 or more 0.60 or less;
[14] the multilayer film according to any one of [1] through [13], wherein an oxygen transmission rate under conditions of 20° C. and 65% RH is 5 cc/(m²·day·atm) or less;
[15] the multilayer film according to any one of [1] through [14], wherein a water vapor transmission rate under conditions of 40° C. and 90% RH is 5 g/(m²·day) or less;
[16] the multilayer film according to any one of [1] through [15], wherein an elongation at break is 8.0 mm or more when humidity is conditioned for 24 hours under conditions of 23° C. and 50% RH and then a needle with a tip diameter of 1 mm pierces at a rate of 50 mm/min under the same conditions;
[17] the multilayer film according to any one of [1] through [16], wherein a strength at break is 8.5 N or more when humidity is conditioned for 24 hours under conditions of 23° C. and 50% RH and then a needle with a tip diameter of 1 mm pierces at a rate of 50 mm/min under the same conditions;
[18] the multilayer film according to any one of [1] through [17], wherein the multilayer film has a laminated structure in which the thermoplastic resin layer (C), an adhesive layer (B1), the barrier layer (A), an adhesive layer (B2), and the heat seal layer (D) are laminated in this order;
[19] a multilayer structure, wherein the multilayer film according to any one of [1] through and at least one resin layer (R) containing a thermoplastic resin (h) as a main component are laminated;
[20] the multilayer structure according to [19], wherein the thermoplastic resin (h) contains a polyethylene resin as a main component;
[21] a packaging material, comprising the multilayer film or the multilayer structure according to any one of [1] through [20];
[22] a recycled composition, comprising a recycled material from the multilayer film or the multilayer structure according to any one of [1] through [20]; and
[23] a method of recycling a multilayer film or a multilayer structure, comprising grinding the multilayer film or the multilayer structure according to any one of [1] through [20], followed by melt molding.

### Advantageous Effects of Invention

The multilayer film and the multilayer structure of the present invention as well as the packaging material using the same are excellent in barrier properties, mechanical properties, and recyclability.

### DESCRIPTION OF EMBODIMENTS

Embodiments of the present invention are described below. It should be noted that, in the following description, specific materials (compounds, etc.) may be an example of what exhibits a specific function while the present invention is not limited to the embodiments using such a material. In addition, the materials mentioned as an example may be used singly or in combination unless otherwise specified.

The multilayer film of the present invention includes: a barrier layer (A) containing an EVOH (a), as a main component, having an ethylene unit content from 20 to 50 mol % and a degree of saponification of 90 mol % or more; an adhesive layer (B) containing an adhesive resin (b) as a main component; a thermoplastic resin layer (C) containing a polyethylene-based resin (c) as a main component, the resin (c) having a density from 0.941 to 0.980 g/cm³; and a heat seal layer (D) containing an ethylene-α-olefin copolymer resin (d) as a main component, the resin (d) having a density from 0.880 to 0.920 g/cm³, wherein the multilayer film has the barrier layer (A) between at least a pair of the thermoplastic resin layer (C) and the heat seal layer (D) and has no layer containing a resin with a melting point of 200° C. or more as a main component and no metal layer with a thickness of 1 μm or more, and when a temperature is risen from −50° C. to 220° C. at 10° C./min (first temperature rise) and then lowered to −50° C. at 10° C./min and further risen to 220° C. at 10° C./min (second temperature rise) using a differential scanning calorimeter (DSC), a ratio (H1/H2) of a total heat of fusion (H1) from 0° C. to 150° C. during the first temperature rise to a total heat of fusion (H2) from 0° C. to 150° C. during the second temperature rise is from 0.75 to 1.01. In this context, “containing as a main component” means to contain more than 50 mass %, preferably 70 mass % or more, more preferably 80 mass % or more, and even more preferably 90 mass % or more and may be 95 mass % or more, 97 mass % or more, or 99 mass % or more. The multilayer film of the present invention includes the barrier layer (A), thereby giving a tendency to allow an increase in gas barrier properties while maintaining recyclability. In addition, the multilayer film includes the adhesive layer (B), thereby giving a tendency to allow an increase in mechanical strength and recyclability. Still in addition, the thermoplastic resin layer (C) contains the polyethylene-based resin (c) as a main component, the resin (c) having a density from 0.941 to 0.980 g/cm³, thereby having a tendency to be excellent in water vapor barrier properties. Still in addition, the heat seal layer (D) containing the ethylene-α-olefin copolymer resin (d) as a main component, the resin (d) having a density from 0.880 to 0.920 g/cm³, thereby having a tendency to allow achievement of excellent mechanical strength. Still in addition, the multilayer film of the present invention has no layer containing a resin with a melting point of 200° C. or more as a main component and no metal layer with a thickness of 1 μm or more, thereby being capable of exhibiting good recyclability. “Having no layer containing a resin with a melting point of 200° C. or more as a main component and no metal layer with a thickness of 1 μm or more” means to have no layer containing a resin with a melting point of 200° C. or more as a main component and also to have no metal layer with a thickness of 1 μm or more. Moreover, the multilayer film of the present invention has the ratio (H1/H2) of the heat of fusion from 0.75 to 1.01, thereby allowing efficient improvement of mechanical strength even if the multilayer film is thin (e.g., 200 μm or less). The multilayer film of the present invention has a configuration to include the barrier layer (A) between at least a pair of the thermoplastic resin layer (C) and the heat seal layer (D), thereby having a tendency to readily cool the thermoplastic resin layer (C) and the heat seal layer (D) and to be capable of readily adjusting the ratio (H1/H2) of heat of fusion. The recyclability herein may be assessed by evaluation of hard spots and coloration in a melt molded product of the ground multilayer film and the melt viscosity stability of the ground multilayer film, and specifically may be evaluated by the methods described in Examples. The mechanical strength herein may be assessed by evaluation of puncture strength and elongation at break, impact strength, and drop resistance of bags to breakage, and specifically may be evaluated by the methods described in Examples. The “barrier properties” herein mean oxygen barrier properties and water vapor barrier properties, and the “gas barrier properties” means oxygen barrier properties.

### EVOH (a) and Barrier Layer (A)

The multilayer film of the present invention has the barrier layer (A) containing the EVOH (a) as a main component. Since the EVOH (a) is excellent in gas barrier properties, the multilayer film having a layer containing the EVOH (a) as a main component is preferably used as a packaging material with high content storage properties. In addition, since the EVOH (a) can be readily melt mixed with a polyethylene-based resin, it is possible to provide packaging materials excellent in recyclability. Still in addition, the EVOH (a) content in the barrier layer (A) has to be more than 50 mass %, preferably 70 mass % or more, more preferably 90 mass % or more, and even more preferably 95 mass % or more.

The EVOH (a) is usually produced by saponifying an ethylene-vinyl ester copolymer obtained by polymerizing ethylene and a vinyl ester. A typical example of the vinyl ester includes vinyl acetate, and other fatty acid vinyl esters (vinyl formate, vinyl propionate, vinyl valerate, vinyl caprate, vinyl laurate, vinyl stearate, vinyl benzoate, vinyl pivalate, vinyl versatate, etc.) may also be used.

The EVOH (a) has an ethylene unit content from 20 to 50 mol %. The ethylene unit content of 20 mol % or more improves the melt moldability of the EVOH (a) and a ground product of the multilayer film containing the EVOH (a). The ethylene unit content is preferably 23 mol % or more, more preferably 26 mol % or more, and may be 29 mol % or more. Meanwhile, the ethylene unit content of 50 mol % or less improves the gas barrier properties of the multilayer film of the present invention. The ethylene unit content is preferably 46 mol % or less, more preferably 42 mol % or less, and may be 38 mol % or less. In addition, the EVOH (a) has a degree of saponification of 90 mol % or more. The degree of saponification means the ratio of the number of vinyl alcohol units to the total number of vinyl alcohol units and vinyl ester units in the EVOH (a). The degree of saponification of 90 mol % or more improves the gas barrier properties of the multilayer film of the present invention. The degree of saponification is preferably 95 mol % or more, more preferably 99 mol % or more, and even more preferably 99.9 mol % or more. The degree of saponification may be 100 mol % or less. The ethylene unit content and the degree of saponification of the EVOH (a) are obtained by 1H-NMR measurement.

The EVOH (a) may be a mixture of two or more kinds of EVOH with different ethylene unit contents. In this case, the difference in the ethylene unit content between EVOHs with the most distant ethylene unit contents from each other is preferably 30 mol % or less, more preferably 25 mol % or less, even more preferably 20 mol % or less, and may be 3 mol % or more. Similarly, the EVOH (a) may be a mixture of two or more kinds of EVOH with different degrees of saponification. In this case, the difference in the degree of saponification between EVOHs with the most distant degrees of saponification from each other is preferably 7 mol % or less, more preferably 5 mol % or less, and may be 0.5 mol % or more. To obtain both thermoformability and gas barrier properties at a higher level, it is preferable to mix an EVOH (a1) with an ethylene unit content of 22 mol % or more and less than 34 mol % and a degree of saponification of 99 mol % or more and an EVOH (a2) with an ethylene unit content of 34 mol % or more and less than 50 mol % and a degree of saponification of 99 mol % or more with a mixing mass ratio (a1/a2) from 60/40 to 90/10 to be used as the EVOH (a).

The EVOH (a) may contain monomer units other than ethylene, vinyl esters, and vinyl alcohols as long as the effects of the present invention are not impaired. In particular, introduction of a modified group containing a primary hydroxyl group with a specific structure sometimes allows the EVOH (a) to obtain both gas barrier properties and molding processability at a high level. The content of other monomer units is preferably 10 mol % or less, more preferably 5 mol % or less, even more preferably 1 mol % or less, and particularly preferably substantially not contained. Examples of such another monomer include: alkenes, such as propylene, butylene, pentene, and hexene; ester group-containing alkenes, such as 3-acyloxy-1-propene, 3-acyloxy-1-butene, 4-acyloxy-1-butene, 3, 4-diacyloxy-1-butene, 3-acyloxy-4-methyl-1-butene, 4-acyloxy-1-butene, 3,4-diacyloxy-1-butene, 3-acyloxy-4-methyl-1-butene, 4-acyloxy-2-methyl-1-butene, 4-acyloxy-3-methyl-1-butene, 3,4-diacyloxy-2-methyl-1-butene, 4-acyloxy-1-pentene, 5-acyloxy-1-pentene, 4,5-diacyloxy-1-pentene, 4-acyloxy-1-hexene, 5-acyloxy-1-hexene, 6-acyloxy-1-hexene, 5,6-diacyloxy-1-hexene, and 1,3-diacetoxy-2-methylenepropane, and saponification products thereof; unsaturated acids, such as acrylic acid, methacrylic acid, crotonic acid, and itaconic acid, and anhydrides, salts, mono- and di-alkyl esters, and the like thereof; nitriles, such as acrylonitrile and methacrylonitrile; amides, such as acrylamide and methacrylamide; olefin sulfonic acids, such as vinylsulfonic acid, allylsulfonic acid, and methalylsulfonic acid, and salts thereof; vinyl silane compounds, such as vinyltrimethoxysilane, vinyltriethoxysilane, vinyltri(β-methoxy-ethoxy) silane, and γ-methacryloxypropylmethoxysilane; alkyl vinyl ethers; vinyl ketones; N-vinylpyrrolidone; vinyl chloride; vinylidene chloride; and the like.

The EVOH (a) may be modified by urethanization, acetalization, cyanoethylation, oxyalkylenation, and the like as needed. The oxyalkylenation may be carried out using epoxy compounds, and examples of them include: epoxyethane (ethylene oxide); epoxypropane; 1,2-epoxybutane; 2,3-epoxybutane; 3-methyl-1,2-epoxybutane; 1,2-epoxypentane; 3-methyl-1,2-epoxypentane; 1,2-epoxyhexane; 2,3-epoxyhexane; 3,4-epoxyhexane; 3-methyl-1,2-epoxyhexane; 3-methyl-1,2-epoxyheptane; 4-methyl-1,2-epoxyheptane; 1,2-epoxyoctane; 2,3-epoxyoctane; 1,2-epoxynonane; 2,3-epoxynonane; 1,2-epoxydecane; 1,2-epoxydodecane; epoxyethylbenzene; 1-phenyl-1,2-propane; 3-phenyl-1,2-epoxypropane; various alkyl glycidyl ethers; various alkylene glycol monoglycidyl ethers; various alkenyl glycidyl ethers; various epoxy alkanols, such as glycidol; various epoxycycloalkanes; various epoxycycloalkenes; and the like. Among them, 1,2-epoxybutane, 2,3-epoxybutane, epoxypropane, epoxyethane, and glycidol are preferred, and epoxypropane and glycidol are more preferred.

The EVOH (a) has a MFR measured in accordance with JIS K7210 (2014) (190° C., under a load of 2.16 kg) preferably from 0.2 to 20 g/10 min. The MFR of the EVOH (a) is more preferably 0.5 g/10 min or more, and even more preferably 0.8 g/10 min or more. Meanwhile, the MFR of the EVOH (a) is more preferably 15 g/10 min or less, even more preferably 10 g/10 min or less, yet even more preferably 5 g/10 min or less, and particularly preferably 3 g/10 min or less. The EVOH (a) having the MFR within the above range improves the melt moldability of the EVOH (a) and the ground product of the multilayer film containing the EVOH (a) (the multilayer film of the present invention).

### Polyvalent Metal Ion (g)

The barrier layer (A) preferably contains from 10 to 200 ppm of polyvalent metal ions (g) that are at least one selected from the group consisting of magnesium ions, calcium ions, and zinc ions. Content of a certain amount of the polyvalent metal ions (g) inhibits thickening, gelation, and resin adhesion to the screw during melt molding of the EVOH (a) and the ground product of the multilayer film containing the EVOH (a). The barrier layer (A) more preferably contains magnesium ions or calcium ions as the polyvalent metal ions (g) and even more preferably contains magnesium ions. In addition, the polyvalent metal ions (g) are preferably contained as a carboxylate. The carboxylic acid in this procedure may be either an aliphatic carboxylic acid or an aromatic carboxylic acid and is preferably an aliphatic carboxylic acid. Examples of the aliphatic carboxylic acid include formic acid, acetic acid, propionic acid, butyric acid, lauric acid, stearic acid, myristic acid, behenic acid, montanic acid, and the like and more preferably higher fatty acids with a carbon number from 10 to 25. In addition, from the perspective of inhibiting coloration during melt molding, it is also preferable that the polyvalent metal ions (g) are contained as a salt of a polyvalent carboxylic acid described later.

The barrier layer (A) preferably contains from 10 to 200 ppm of the polyvalent metal ions (g) in terms of metal atoms. The content of 10 ppm or more causes good viscosity stability of the EVOH (a) and the ground product of the multilayer film containing the EVOH (a) and inhibits gelation of the resin and adhesion of the resin to the extruder screw. The lower limit of the content of the polyvalent metal ions (g) is more preferably 20 ppm. Meanwhile, the content of the polyvalent metal ions (g) of 200 ppm or less inhibits excessive degradation of the ground product of the multilayer film containing the EVOH (a) and causes a good hue of the recycled composition. The upper limit of the content of the polyvalent metal ions (g) is more preferably 160 ppm and even more preferably 120 ppm.

The barrier layer (A) may contain components other than the EVOH (a) and the polyvalent metal ions (g) as long as the effects of the present invention are not impaired. Examples of such another component include alkali metal ions, polyvalent metal ions other than the polyvalent metal ions (g), carboxylic acids, phosphoric acid compounds, boron compounds, prooxidants, antioxidants, plasticizers, thermal stabilizers (melt stabilizers), photoinitiators, deodorants, ultraviolet absorbers, antistatic agents, lubricants, colorants, fillers, desiccants, fillers, pigments, dyes, processing aids, flame retardants, antifogging agents, and the like. In particular, from the perspective of improving the interlayer adhesion and the melt moldability of a laminate containing the EVOH (a), it is preferable to contain alkali metal ions. In addition, from the perspective of allowing inhibition of coloration during melt molding the EVOH (a) and a recycled resin containing the EVOH (a), it is preferable to contain a carboxylic acid and/or a phosphoric acid compound. Moreover, content of a boron compound may allow control of the melt viscosity of the EVOH (a) and the recycled resin containing the EVOH (a) and may also allow improvement of the mechanical strength of the multilayer film of the present invention. The content of other components in the barrier layer (A) is usually 5 mass % or less, preferably 3 mass % or less, and more preferably 1 mass % or less.

### Alkali Metal Ion

The barrier layer (A) preferably contains from 10 to 400 ppm of alkali metal ions. The lower limit of the alkali metal ion content is more preferably 100 ppm and even more preferably 150 ppm. Meanwhile, the upper limit of the alkali metal ion content is more preferably 350 ppm and may be 250 ppm. The alkali metal ion content of 10 ppm or more causes good interlayer adhesion in the multilayer film of the present invention including the layer obtained by molding the EVOH (a). Meanwhile, the alkali metal ion content of 400 ppm or less tends to allow inhibition of coloration. In addition, control of the content ratio of the alkali metal ions and carboxylic acids described below allows even more improvement of melt moldability and coloration resistance.

Examples of the alkali metal ions include ions of lithium, sodium, potassium, rubidium, and cesium and ions of sodium or potassium are preferred from the perspective of industrial availability. In particular, use of sodium ions sometimes allows both a hue and interlayer adhesion to the adhesive layer (B) to be obtained at a high level. They may be used singly or in combination of two or more kinds.

Examples of alkali metal salts to provide the alkali metal ions include aliphatic carboxylates, aromatic carboxylates, carbonates, hydrochlorides, nitrates, sulfates, phosphates, and metal complexes of alkali metals, such as sodium and potassium. Among them, at least one selected from the group consisting of sodium acetate, potassium acetate, sodium phosphate, and potassium phosphate is more preferable from the perspective of availability.

### Carboxylic Acid

The barrier layer (A) preferably contains a carboxylic acid. The lower limit of the carboxylic acid content is preferably 50 ppm and more preferably 100 ppm. Meanwhile, the upper limit of the carboxylic acid content is preferably 400 ppm and more preferably 350 ppm. The carboxylic acid content within the above range tends to allow inhibition of hue deterioration. The carboxylic acid content is determined by extracting 10 g of the resin composition constituting the barrier layer (A) with 50 ml of pure water at 95° C. for 8 hours, followed by titration of the extract thus obtained. It should be noted that carboxylic acids in the form of salts in the extract are not considered as the carboxylic acid content in the resin composition. In addition, if the resin composition contains acidic compounds other than carboxylic acids, subtraction of the contribution of the acidic compounds from the measured value by titration allows determination of the carboxylic acid content in the resin composition.

The carboxylic acid preferably has a pKa from 3.5 to 5.5. The carboxylic acid with a pKa within the above range increases the pH buffer capacity in the weak acidic range and further improves melt moldability, and also allows even more reduction in the influence of coloration due to acidic substances and basic substances.

The carboxylic acid may be any of monovalent carboxylic acids. They may be used singly or in combination of two or more kinds. Such a monovalent carboxylic acid refers to a compound having one carboxyl group in the molecule. Examples of the monovalent carboxylic acids with a pKa in the range from 3.5 to 5.5 include, but not particularly limited to, formic acid (pKa=3.77), acetic acid (pKa=4.76), propionic acid (pKa=4.85), acrylic acid (pKa=4.25), and the like. These carboxylic acids may further have a substituent group, such as a hydroxyl group, an amino group, and a halogen atom. Among them, acetic acid is preferred due to the high safety and ease of availability and handling.

The carboxylic acid may be any of polyhydric carboxylic acids. The carboxylic acid as a polyhydric carboxylic acid sometimes even more improves the coloration resistance of the EVOH (a) at high temperatures and the coloration resistance of a melt molded product of a ground multilayer film containing the EVOH (a). In addition, it is also preferable that the polyhydric carboxylic acid compound has three or more carboxyl groups. In this case, the coloration resistance may be improved more effectively. Such a polyhydric carboxylic acid refers to a compound having two or more carboxyl groups in the molecule. In this case, at least one carboxyl group preferably has a pKa in the range from 3.5 to 5.5 and examples include oxalic acid (pKa2=4.27), succinic acid (pKa1=4.20), fumaric acid (pKa2=4.44), malic acid (pKa2=5.13), glutaric acid (pKa1=4.30, pKa2=5.40), adipic acid (pKa1=4.43, pKa2=5.41), pimelic acid (pKa1=4.71), phthalic acid (pKa2=5.41), isophthalic acid (pKa2=4.46), terephthalic acid (pKa1=3.51, pKa2=4.82), citric acid (pKa2=4.75), tartaric acid (pKa2=4.40), glutamic acid (pKa2=4.07), aspartic acid (pKa=3.90), and the like.

### Phosphoric Acid Compound

The barrier layer (A) may further contain a phosphoric acid compound. The lower limit of the phosphoric acid compound content is preferably 5 ppm in terms of phosphate radicals. Meanwhile, the upper limit of the phosphoric acid compound content is preferably 100 ppm in terms of phosphate radicals. Content of the phosphoric acid compound within this range may inhibit coloration of the EVOH (a) and a melt molded product of a ground product of the multilayer film and improve thermal stability.

Examples of the phosphoric acid compound to be used include various acids, such as phosphoric acid and phosphorous acid, salts thereof, and the like. The phosphate may be any of a primary phosphate, a secondary phosphate, or a tertiary phosphate. The cationic species of the phosphate are preferably, but not particularly limited to, alkali metals or alkaline earth metals. Among them, preferred phosphoric acid compounds include sodium dihydrogen phosphate, potassium dihydrogen phosphate, disodium hydrogen phosphate, and dipotassium hydrogen phosphate.

### Boron Compound

The barrier layer (A) may further contain a boron compound. The lower limit of the boron compound content is preferably 50 ppm and more preferably 100 ppm in terms of boron elements. Meanwhile, the upper limit of the boron compound content is preferably 400 ppm and more preferably 200 ppm in terms of boron elements. Content of the boron compound in this range may improve the thermal stability of the EVOH (a) and a ground product of the multilayer film during melt molding and inhibit generation of gel and hard spots. In some cases, it also improves drawdown resistance and neck-in resistance during film formation and improves mechanical properties of the multilayer film. These effects are assumed to result from the chelate interaction between the EVOH (a) and the boron compound.

Examples of the boron compound include boric acids, borate esters, borates, and boron hydride. Specific examples include: boric acids, such as orthoboric acid (H3BO3), metaboric acid, and tetraboric acid; borate esters, such as trimethyl borate and triethyl borate; borates, such as alkali metal salts, alkaline earth metal salts, and borax, of the above boric acids; and the like. Among them, orthoboric acid is preferred.

### Hindered Phenol-Based Compound

The barrier layer (A) may further contain, for example, a hindered phenol-based compound with an ester bond or an amide bond as an antioxidant. The content of the hindered phenol-based compound is preferably from 1000 to 10000 ppm. The content of 1000 ppm or more allows inhibition of coloration, thickening, and gelation of the resin during melt molding of the ground product of the multilayer film. The content of the hindered phenol-based compound is more preferably 2000 ppm or more. Meanwhile, the content of the hindered phenol-based compound of 10000 ppm or less allows inhibition of coloration and bleed out derived from the hindered phenol-based compound. The content of the hindered phenol-based compound is more preferably 8000 ppm or less.

The hindered phenol-based compound has at least one hindered phenol group. A hindered phenol group is a group in which a bulky substituent is bonded to at least one carbon atom adjacent to the carbon to which the hydroxyl group of phenol is bonded. As the bulky substituent, an alkyl group with 1 to 10 carbon atoms is preferable and a t-butyl group is more preferable.

The hindered phenol-based compound is preferably in a solid state near room temperature. From the perspective of inhibiting bleed out of the compound, the hindered phenol-based compound preferably has a melting point or a softening temperature of 50° C. or more, more preferably 60° C. or more, and even more preferably 70° C. or more. In addition, from the perspective of inhibiting bleed out, the hindered phenol-based compound preferably has a molecular weight of 200 or more, more preferably 400 or more, and even more preferably 600 or more. Meanwhile, the molecular weight is usually 2000 or less. Still in addition, from the perspective of facilitating mixing with the EVOH (a), the hindered phenol-based compound preferably has a melting point or a softening temperature of 200° C. or less, more preferably 190° C. or less, and even more preferably 180° C. or less.

The hindered phenol-based compound has an ester bond or an amide bond. Examples of the hindered phenol-based compound with an ester bond include esters of aliphatic carboxylic acids with a hindered phenol group and aliphatic alcohols, and examples of the hindered phenol-based compound with an amide bond include amides of aliphatic carboxylic acids with a hindered phenol group and aliphatic amines. Among them, the hindered phenol-based compound preferably has an amide bond from the perspective of facilitating mixing with the EVOH (a).

Specific structure examples of the hindered phenol-based compound include pentaerythritol tetrakis[3-(3,5-di-tert-butyl-4-hydroxyphenyl) propionate] commercially available from BASF as Irganox 1010 and 3-(3,5-di-tert-butyl-4-hydroxyphenyl) stearyl propionate commercially available as Irganox 1076, 2,2′-thiodiethylbis[3-(3,5-di-tert-butyl-4-hydroxyphenyl) propionate] commercially available as Irganox 1035, 3-(3,5-di-tert-butyl-4-hydroxyphenyl) octadecyl propanoate commercially available as Irganox 1135, bis(3-tert-butyl-4-hydroxy-5-methylbenzenepropanoic acid)ethylenebis(oxyethylene) commercially available as Irganox 245, 1,6-hexanediol bis[3-(3,5-di-tert-butyl-4-hydroxyphenyl) propionate] commercially available as Irganox 259, and N,N′-hexamethylene bis[3-(3,5-di-tert-butyl-4-hydroxyphenyl) propanamide] commercially available as Irganox 1098. Among them, N,N′-hexamethylene bis[3-(3,5-di-tert-butyl-4-hydroxyphenyl) propanamide] commercially available as Irganox 1098 and pentaerythritol tetrakis[3-(3,5-di-tert-butyl-4-hydroxyphenyl) propionate] commercially available as Irganox 1010 are preferred and Irganox 1098 is more preferred.

The barrier layer (A) may further contain a thermoplastic resin other than the EVOH (a). Examples of the thermoplastic resin other than the EVOH (a) include various polyolefins (polyethylene, polypropylene, poly 1-butene, poly 4-methyl-1-pentene, ethylene-propylene copolymers, copolymers of ethylene and α-olefins with a carbon number 4 or more, copolymers of polyolefins with maleic anhydrides, ethylene-vinyl ester copolymers, ethylene-acrylic ester copolymers, or modified polyolefins obtained by graft modification with an unsaturated carboxylic acid or a derivative thereof, etc.), various polyamides (nylon 6, nylon 6-6, nylon 6/66 copolymers, nylon 11, nylon 12, polymetaxylylene adipamide, etc.), various polyesters (polyethylene terephthalate, polybutylene terephthalate, polyethylene naphthalate, etc.), polyvinyl chlorides, polyvinylidene chlorides, polystyrenes, polyacrylonitriles, polyurethanes, polycarbonates, polyacetals, polyacrylates, modified polyvinyl alcohol resins, and the like. The content of the above thermoplastic resin in the barrier layer (A) is less than 50 mass %, preferably 30 mass % or less, more preferably 10 mass % or less, even more preferably 5 mass % or less, and may be 1 mass % or less.

The ratio of the EVOH (a) as the resin constituting the barrier layer (A) is preferably 60 mass % or more, more preferably 80 mass % or more, and even more preferably 90 mass % or more, and may be 95 mass % or more, 97 mass %, and 99 mass % or more, and the resin constituting the barrier layer (A) may be composed only of the EVOH (a). In addition, the ratio of the EVOH (a) in the barrier layer (A) is preferably 60 mass % or more, more preferably 80 mass % or more, and even more preferably 90 mass % or more, and may be 95 mass % or more, 97 mass % or more, and 99 mass % or more, and the barrier layer (A) may be substantially composed only of the EVOH (a).

When the barrier layer (A) contains components other than the EVOH (a), the method of producing the resin composition constituting the barrier layer (A) is not particularly limited, and the method allows production by melt kneading the EVOH (a) and, as needed, other additives (polyvalent metal ions (g), etc.). Such another additive may be mixed directly in a solid state, such as a powder, or as a melt, or may be mixed as a solute to be contained in a solution or as a dispersoid contained in a dispersion. As the solution and the dispersion, aqueous solutions and aqueous dispersions are preferred, respectively. For melt kneading, it is possible to use a known mixing device or kneading device, such as a kneader ruder, an extruder, mixing rolls, and a Banbury mixer, for example. The temperature range during melt kneading may be adjusted appropriately in accordance with the melting point of the EVOH (a) to be used and the like, and the range from 150° C. to 300° C. is usually employed.

In another embodiment, a masterbatch containing a high concentration of other additives with respect to the EVOH (a) may be produced by melt kneading and dry blended with the EVOH (a) containing substantially no other additives to be used for production of multilayer films. In still another embodiment, the EVOH (a) and other additives may be dry blended to be used for production of multilayer films. Dry blending refers to mechanical mixing in the form of powder granules or pellets. Mixing may be performed using a mixing device, such as a tumbler, a ribbon mixer, and a Henschel mixer, or by manual stirring, shaking, and the like in a well-closed container. The mixing temperature may be from room temperature to below the melting point of the EVOH (a), and the mixing may be carried out in an air atmosphere or a nitrogen atmosphere.

### Adhesive Resin (b) and Adhesive Layer (B)

The multilayer film of the present invention has the adhesive layer (B) containing the adhesive resin (b) as a main component. The adhesive layer (B) has a function of adhering the barrier layer (A) to the thermoplastic resin layer (C) or the barrier layer (A) to the heat seal layer (D). Accordingly, the adhesive layer (B) is preferably provided between the barrier layer (A) and the thermoplastic resin layer (C) or between the barrier layer (A) and the heat seal layer (D) and is preferably directly laminated on the barrier layer (A) and the thermoplastic resin layer (C) or on the barrier layer (A) and the heat seal layer (D). The adhesive layer (B) between the barrier layer (A) and the thermoplastic resin layer (C) is referred to as an adhesive layer (B1), and the resin constituting the adhesive layer (B1) is referred to as an adhesive resin (b1). In addition, the adhesive layer (B) between the barrier layer (A) and the heat seal layer (D) is referred to as an adhesive layer (B2), and the resin constituting the adhesive layer (B2) is referred to as an adhesive resin (b2). The adhesive resin (b1) and the adhesive resin (b2) may be identical or different. The content of the adhesive resin (b) in the adhesive layer (B) has to be more than 50 mass %, preferably 70 mass % or more, more preferably 90 mass % or more, and even more preferably 95 mass % or more.

Examples of the adhesive resin (b) include modified olefin polymers containing a carboxyl group obtained by chemically bonding an unsaturated carboxylic acid or an anhydride thereof to an olefin-based polymer by an addition reaction, a graft reaction, and the like. Examples of the unsaturated carboxylic acid or an anhydride thereof include maleic acid, maleic anhydride, fumaric acid, acrylic acid, methacrylic acid, crotonic acid, itaconic acid, citraconic acid, hexahydrophthalic anhydride, and the like, and among them, maleic anhydride is preferably used. Specifically, preferred examples include one kind or a mixture of two or more kinds selected from maleic anhydride grafted polyethylene, maleic anhydride grafted polypropylene, a maleic anhydride grafted ethylene-propylene copolymer, a maleic anhydride grafted ethylene-ethyl acrylate copolymer, a maleic anhydride grafted ethylene-vinyl acetate copolymer, or the like, and among them, maleic anhydride grafted polyethylene is most preferred. Such an adhesive resin (b) usually has an acid value from 0.5 to 5 mg KOH/g and preferably from 1 to 4 mg KOH/g. In addition, when the adhesive resin (b) is the adhesive resin (b1), the resin (b1) preferably has an acid value of 0.50 mg KOH/g or more and 2.50 mg KOH/g or less. The adhesive resin (b1) with an acid value within the above range allows the resulting multilayer film to obtain both appearance properties and adhesion at a high level. The acid value of the adhesive resin (b) may be measured in accordance with JIS K 0070:1992 using xylene as a solvent.

The adhesive resin (b) of the present invention may be a mixture of an unmodified resin (bx) and an acid-modified resin (by). In this case, from the perspective of more increasing mechanical strength, the unmodified resin (bx) preferably contains an ethylene-α-olefin copolymer resin (d) described later and is more preferably the ethylene-α-olefin copolymer resin (d). In this context, when the unmodified resin (bx) contains the ethylene-α-olefin copolymer resin (d), the ethylene-α-olefin copolymer resin (d) contained in the adhesive layer (B) and the ethylene-α-olefin copolymer resin (d) contained in the heat seal layer (D) may be identical or different, but preferably identical. In addition, the adhesive resin (b) preferably has a ratio (bx/by) of the unmodified resin (bx) to the acid-modified resin (by) from 55/45 to 95/5 and preferably 65/35 to 90/10. In this case, as the acid-modified resin (by), a resin with a relatively high degree of acid modification may be preferably used, and the acid value is preferably from 5 to 30 mg KOH/g and more preferably from 8 to 20 mg KOH/g. This sometimes allows further improvement in the mechanical strength of the multilayer film to be obtained while maintaining the necessary interlayer adhesion strength. When the adhesive resin (b) of the present invention is the mixture of the unmodified resin (bx) and the acid-modified resin (by), a material prepared by melt kneading the unmodified resin (bx) and the acid-modified resin (by) in advance may be used or a dry blend of the unmodified resin (bx) and the acid-modified resin (by) may be used. For melt kneading, it is possible to use a known mixing device or kneading device, such as a kneader ruder, an extruder, mixing rolls, and a Banbury mixer, for example. The temperature range during melt kneading may be adjusted appropriately in accordance with the melting points of the unmodified resin (bx) and the acid-modified resin (by) to be used and the like, and the range from 150° C. to 300° C. is usually employed. Dry blending refers to mechanical mixing in the form of powder granules or pellets. Mixing may be performed using a mixing device, such as a tumbler, a ribbon mixer, and a Henschel mixer, or by manual stirring, shaking, and the like in a well-closed container. The mixing temperature may be from room temperature to below the melting points of the unmodified resin (bx) and the acid-modified resin (by), and the mixing may be carried out in an air atmosphere or a nitrogen atmosphere.

The adhesive layer (B) may contain components other than the adhesive resin (b) as long as the effects of the present invention are not impaired. Examples of such another component include alkali metal ions, polyvalent metal ions, carboxylic acids, phosphoric acid compounds, boron compounds, prooxidants, antioxidants, plasticizers, thermal stabilizers (melt stabilizers), photoinitiators, deodorants, ultraviolet absorbers, antistatic agents, lubricants, colorants, fillers, desiccants, fillers, pigments, dyes, processing aids, flame retardants, antifogging agents, and the like. The content of other components in the adhesive layer (B) is usually 5 mass % or less, preferably 3 mass % or less, and more preferably 1 mass % or less. In addition, the adhesive layer (B) may further contain a thermoplastic resin other than the adhesive resin (b). As the thermoplastic resin, it is possible to use each resin mentioned above as an example of the thermoplastic resin that may be contained in the barrier layer (A). The content of the above thermoplastic resin in the adhesive layer (B) is less than 50 mass %, preferably less than 30 mass %, more preferably less than 10 mass %, even more preferably 5 mass % or less, and may be 1 mass % or less.

The ratio of the adhesive resin (b) as the resin constituting the adhesive layer (B) is preferably 60 mass % or more, more preferably 80 mass % or more, and even more preferably 90 mass % or more, and may be 95 mass % or more, 97 mass % or more, and 99 mass % or more, and the resin constituting the adhesive layer (B) may be composed only of the adhesive resin (b). In addition, the ratio of the adhesive resin (b) in the adhesive layer (B) is preferably 60 mass % or more, more preferably 80 mass % or more, and even more preferably 90 mass % or more, and may be 95 mass % or more, 97 mass %, and 99 mass % or more, and the adhesive layer (B) may be substantially composed only of the adhesive resin (b).

### Polyethylene-Based Resin (c) and Thermoplastic Resin Layer (C)

The multilayer film of the present invention has the thermoplastic resin layer (C) containing the polyethylene-based resin (c) as a main component, the resin (c) having a density from 0.941 to 0.980 g/cm³. The thermoplastic resin layer (C) has a function of reducing the water vapor transmission rate of the multilayer film to be obtained. The content of the polyethylene-based resin (c) in the thermoplastic resin layer (C) has to be more than 50 mass %, preferably 70 mass % or more, more preferably 90 mass % or more, and even more preferably 95 mass % or more.

The polyethylene-based resin (c) has a density from 0.941 to 0.980 g/cm³. The density within the above range improves the water vapor barrier properties of the multilayer film to be obtained. The lower limit of the density is preferably 0.945 g/cm³, more preferably 0.950 g/cm³, and even more preferably 0.955 g/cm³. The upper limit of the density is preferably 0.975 g/cm³, more preferably 0.970 g/cm³, and even more preferably 0.965 g/cm³.

The polyethylene-based resin (c) has an MFR (190° C., under a load of 2.16 kg) is preferably from 0.5 to 2.0 g/10 min. The MFR within the above range causes the polyethylene-based resin (c) to be excellent in melt processability and improves various mechanical strengths, such as puncture strength and elongation and tensile strength and elongation, of the multilayer film to be obtained. The lower limit of the MFR is preferably 0.7 g/10 min. The upper limit of the MFR is preferably 1.5 g/10 min and more preferably 1.1 g/10 min. The MFR is measured at 190° C. under a load of 2.16 kg in accordance with JIS K 7210 (2014).

Examples of the polyethylene-based resin (c) include polyethylene resins obtained by polymerizing ethylene and resins obtained by polymerizing ethylene and an α-olefin with a carbon number of 3 or more. Examples of the α-olefin with a carbon number of 3 or more include propylene, 1-butene, 1-pentene, 1-hexene, 1-octene, 1-decene, 1-dodecene, 4-methyl-1-pentene, and the like. Among all, polyethylene resins are preferred from the perspective of water vapor barrier properties, and among them, high density polyethylene (HDPE) is more preferred.

As the polyethylene-based resin (c), commercially available products may be used, and examples include “NOVATEC™ HD” (produced by Japan Polyethylene Corp.), “HI-ZEX™” (produced by Prime Polymer Co., Ltd.), “Evolue™ H” (produced by Prime Polymer Co., Ltd.), and the like.

### Ethylene-α-Olefin Copolymer Resin (d) and Heat Seal Layer (D)

The multilayer film of the present invention has the heat seal layer (D) containing the ethylene-α-olefin copolymer resin (d) as a main component, the resin (d) having a density from 0.880 to 0.920 g/cm³. The heat seal layer (D) has a function of increasing various mechanical strengths, such as puncture strength and elongation and tensile strength and elongation, in addition to a function as a seal layer for forming a packaging material. The content of the ethylene-α-olefin copolymer resin (d) in the heat seal layer (D) has to be more than 50 mass %, preferably 70 mass % or more, more preferably 90 mass % or more, and even more preferably 95 mass % or more.

The ethylene-α-olefin copolymer resin (d) has a density from 0.880 to 0.920 g/cm³. The density within the above range causes the resulting multilayer film to be flexible and excellent in handleability and improves various mechanical strengths, such as puncture strength and elongation and tensile strength and elongation. The lower limit of the density is preferably 0.885 g/cm³, more preferably 0.890 g/cm³, and even more preferably 0.895 g/cm³. The upper limit of the density is preferably 0.915 g/cm³, more preferably 0.910 g/cm³, and even more preferably 0.905 g/cm³.

The ethylene-α-olefin copolymer resin (d) preferably has an MFR (190° C., under a load of 2.16 kg) from 0.5 to 2.0 g/10 min. The MFR within the above range causes the ethylene-α-olefin copolymer resin (d) to be excellent in melt processability and improves various mechanical strengths, such as puncture strength and elongation and tensile strength and elongation, of the multilayer film to be obtained. The lower limit of the MFR is preferably 0.7 g/10 min. The upper limit of the MFR is preferably 1.5 g/10 min and more preferably 1.0 g/10 min. The MFR is measured at 190° C. under a load of 2.16 kg in accordance with JIS K 7210 (2014).

When the temperature of the ethylene-α-olefin copolymer resin (d) is risen at 10° C./min using a differential scanning calorimeter (DSC), the total heat of fusion in the melting curve is preferably 150 J/g or less. The total heat of fusion within the above range causes the ethylene-α-olefin copolymer resin (d) to be excellent in melt processability and the resulting multilayer film to be flexible and improves various mechanical properties, such as puncture strength and elongation and tensile strength and elongation. The total heat of fusion is more preferably 125 J/g or less, even more preferably 100 J/g or less, and particularly preferably 90 J/g or less. The lower limit of the total heat of fusion is preferably, but not particularly limited to, 70 J/g or more and more preferably 80 J/g or more from the perspective of handleability and thermal resistance of the multilayer film to be obtained. The total heat of fusion may be adjusted by adjusting the kind of α-olefin, the ratio of ethylene to α-olefin, the distribution in the polymer chain, the degree of polymerization, and the like.

In the melting curve while the temperature of the ethylene-α-olefin copolymer resin (d) is risen at 10° C./min using a differential scanning calorimeter (DSC), when the melting peak is divided into 100° C. intervals, the heat of fusion at 100° C. or more is preferably 60 J/g or less. The heat of fusion at 100° C. or more within the above range causes the ethylene-α-olefin copolymer resin (d) to have both flexibility and toughness and sometimes improves various mechanical strengths, such as puncture strength and elongation and tensile strength and elongation. The heat of fusion at 100° C. or more is more preferably 50 J/g or less, even more preferably 40 J/g or less, and particularly preferably 30 J/g or less, and may be 20 J/g or less. The lower limit of the heat of fusion at 100° C. or more is preferably, but not particularly limited to, 5 J/g or more and more preferably 10 J/g or more from the perspective of handleability and thermal resistance of the multilayer film to be obtained. The heat of fusion at 100° C. or more may be adjusted by the kind of α-olefin, the ratio of ethylene to α-olefin, the distribution in the polymer chain, the degree of polymerization, and the like.

In the melting curve while the temperature of the ethylene-α-olefin copolymer resin (d) is risen at 10° C./min using a differential scanning calorimeter (DSC), when the melting peak is divided into 100° C. intervals, the ratio (percentage) of the heat of fusion at 100° C. or less to the total heat of fusion is preferably 45% or more. The ratio of the heat of fusion at 100° C. or less within the above range causes the resulting multilayer film to be flexible and improves various mechanical strengths, such as puncture strength and elongation and tensile strength and elongation. The ratio of the heat of fusion at 100° C. or less is more preferably 60% or more and even more preferably 75% or more. The upper limit of the ratio of the heat of fusion at 100° C. or less is preferably, but not particularly limited to, 90% or less and more preferably 85% or less from the perspective of handleability and thermal resistance of the multilayer film to be obtained. The above ratio may be adjusted by the kind of α-olefin, the ratio of ethylene to α-olefin, the distribution in the polymer chain, the degree of polymerization, and the like.

The ethylene-α-olefin copolymer resin (d) is a resin obtained by polymerizing ethylene and an α-olefin with a carbon number of 3 or more. Examples of the α-olefin with a carbon number of 3 or more include propylene, 1-butene, 1-pentene, 1-hexene, 1-octene, 1-decene, 1-dodecene, 4-methyl-1-pentene, and the like. Among them, the ethylene-α-olefin copolymer resin (d) is preferably linear low-density polyethylene obtained by polymerizing ethylene and an α-olefin with a carbon number of 6 or more and more preferably a linear low-density polyethylene obtained by polymerizing ethylene and an α-olefin with a carbon number of 8 or more. The α-olefin copolymerized with ethylene having a relatively large carbon number sometimes particularly improves various mechanical strengths, such as puncture strength and elongation and tensile strength and elongation.

In addition, as a polymerization catalyst, it is preferable to use a metallocene catalyst. The linear low-density polyethylene polymerized using the metallocene catalyst is produced by copolymerizing ethylene and an α-olefin in the presence of a catalyst formed from a compound of a transition metal in group 4 of the periodic table having at least one ligand with a cyclopentadienyl skeleton, preferably zirconium, an organoaluminumoxy compound, and various components added as needed. The linear low-density polyethylene polymerized using the metallocene catalyst is excellent in melt moldability, and the multilayer film to be obtained is excellent in the balance of thermal resistance, flexibility, and mechanical strength.

Industrial products of the linear low-density polyethylene produced by polymerizing ethylene and an α-olefin with a carbon number of 6 or more using a metallocene catalyst are commercially available, and examples include “Evolue™” (produced by Prime Polymer Co., Ltd.), “SUMIKATHENE™” (produced by Sumitomo Chemical Co., Ltd.), “UMERIT™” (produced by Ube-Maruzen Polyethylene Co., Ltd.), “Elite™” (produced by Dow Chemical Co.), and the like.

### Higher Fatty Acid Amide Compound (e)

The heat seal layer (D) preferably contains from 100 to 7000 ppm of a higher fatty acid amide compound (e) with a melting point from 60° C. to 120° C. The higher fatty acid amide compound (e) contained within the above range in the heat seal layer (D) reduces fluctuations in measured mechanical strength values and allows improvement in mechanical strength stability regardless of the storage environment or the measurement position. In particular, even when the multilayer film is stored at high temperatures for a long time, it allows inhibition of fluctuations in mechanical strength and thus allows improvement in reliability as a packaging material.

The lower limit of the content of the higher fatty acid amide compound (e) in the heat seal layer (D) is preferably 100 ppm, more preferably 300 ppm, even more preferably 500 ppm, and particularly preferably 700 ppm. The upper limit of the content of the higher fatty acid amide compound (e) is preferably 7000 ppm, more preferably 5000 ppm, even more preferably 3000 ppm, and particularly preferably 1500 ppm, and may be 1000 ppm. The content of the higher fatty acid amide compound (e) within the above range causes the multilayer film to be excellent in transparency and uniform appearance and allows effective inhibition of fluctuations in mechanical strength, and thus allows improvement in reliability as a packaging material.

The higher fatty acid amide compound (e) is not particularly limited as long as it has a melting point from 60° C. to 120° C. The lower limit of the melting point of the higher fatty acid amide compound (e) is preferably 70° C. The upper limit of the melting point of the higher fatty acid amide compound (e) is preferably 110° C. It is possible to control the melting point by the length and the degree of unsaturation (the number of double bonds in the carbon chain) of the carbon chain, the number of amide groups, the presence of other substituent groups, and the like. Examples of the higher fatty acid amide compound (e) include saturated higher fatty acid bisamides, unsaturated higher fatty acid bisamides, saturated higher fatty acid monoamides, unsaturated higher fatty acid monoamides, and derivatives thereof, and the compound (e) is preferably at least one selected from the group consisting of saturated higher fatty acid monoamides and unsaturated higher fatty acid monoamides, both with a carbon number from 10 to 25. Preferred examples of the saturated higher fatty acid monoamide with a carbon number from 10 to 25 include capric acid amide, lauric acid amide, myristic acid amide, palmitic acid amide, stearic acid amide, arachidic acid amide, behenic acid amide, and the like. Among them, lauric acid amide, stearic acid amide, and behenic acid amide are preferable and stearic acid amide is more preferable from the perspective of economic efficiency and availability. Such an unsaturated higher fatty acid monoamide with a carbon number from 10 to 25 is preferably a monoene higher fatty acid monoamide having a degree of unsaturation of 1 from the perspective of inhibiting coloration, and preferred examples include oleic acid amide, elaidic acid amide, vaccenic acid amide, gadoleic acid amide, eicosenoic acid amide, erucic acid amide, and the like. Among them, oleic acid amide and erucic acid amide are preferred from the perspective of economic efficiency and availability. Saturated higher fatty acid monoamides are preferred from the perspective of thermal stability of the higher fatty acid amide compound (e), and unsaturated higher fatty acid monoamides are preferred from the perspective of exhibiting effects over a wider range of processing conditions. In addition, from the perspective of handleability in the process of producing and processing a multilayer film, the higher fatty acid amide compound (e) sometimes preferably has a carbon number from 12 to 22. In addition, the higher fatty acid amide compound (e) may have a substituent group, such as a hydroxyl group.

In one embodiment of the present invention, the higher fatty acid amide compound (e) preferably contains two or more kinds of higher fatty acid amide compounds with different melting points. In particular, it is preferable to contain an unsaturated higher fatty acid amide compound (e1) with a melting point of 60° C. or more and less than 90° C. and a saturated higher fatty acid amide compound (e2) with a melting point of 90° C. or more and less than 120° C. Thus, even in the case of more diverse storage environments with large fluctuations in temperature and humidity, fluctuations in measured mechanical strength values may be reduced and the mechanical strength stability can be further efficiently improved.

### Inorganic Oxide Particle (f)

The heat seal layer (D) preferably contains from 500 to 5000 ppm of inorganic oxide particles (f) with an average particle diameter from 1 to 30 μm. The heat seal layer (D) containing the inorganic oxide particles (f) within the above range may improve the handleability in the process of producing and processing the multilayer film and allow even more improvement in the mechanical strength stability of the multilayer film. The inorganic oxide particles (f) preferably have an average particle diameter from 2 to 15 μm or more and more preferably from 3 to 10 μm or more. The average particle diameter is the median diameter measured by a light scattering method while circulating a dispersion obtained by dispersing the inorganic oxide particles (f) in water or an organic solvent followed by sufficient stirring. The content of the inorganic oxide particles (f) is preferably from 750 to 4500 ppm and more preferably from 1000 to 4000 ppm. In addition, the inorganic oxide particles (f) preferably have a shape with a small aspect ratio and being close to a perfect sphere.

The inorganic oxide particles (f) are preferably at least one selected from the group consisting of silicon oxide particles and metal oxide particles. The metal constituting the metal oxide particles is preferably at least one selected from the group consisting of aluminum, magnesium, zirconium, cerium, tungsten, molybdenum, titanium, and zinc. Specific examples of an inorganic oxide constituting the inorganic oxide particles (f) include silicon oxide, aluminum oxide, zirconium oxide, magnesium oxide, cerium oxide, tungsten oxide, molybdenum oxide, titanium oxide, zinc oxide, composites thereof (composites of silicon oxide and aluminum oxide, etc.), and the like, and silicon oxide is preferred.

The heat seal layer (D) may contain components other than the ethylene-α-olefin copolymer resin (d), the higher fatty acid amide compound (e), and the inorganic oxide particles (f) as long as the effects of the present invention are not impaired. Examples of such another component include alkali metal ions, polyvalent metal ions, carboxylic acids, phosphoric acid compounds, boron compounds, prooxidants, antioxidants, plasticizers, thermal stabilizers (melt stabilizers), photoinitiators, deodorants, ultraviolet absorbers, antistatic agents, lubricants, colorants, fillers, desiccants, fillers, pigments, dyes, processing aids, flame retardants, antifogging agents, and the like. The content of other components in the heat seal layer (D) is usually 5 mass % or less, preferably 3 mass % or less, and more preferably 1 mass % or less. In addition, the heat seal layer (D) may further contain a thermoplastic resin other than the ethylene-α-olefin copolymer resin (d). As the thermoplastic resin, it is possible to use each resin mentioned above as an example of the thermoplastic resin that may be contained in the barrier layer (A). The content of the above thermoplastic resin in the heat seal layer (D) is less than 50 mass %, preferably less than 30 mass %, more preferably less than 10 mass %, even more preferably 5 mass % or less, and may be 1 mass % or less.

The ratio of the ethylene-α-olefin copolymer resin (d) as the resin constituting the heat seal layer (D) is preferably 60 mass % or more, more preferably 80 mass % or more, and even more preferably 90 mass % or more, and may be 95 mass % or more, 97 mass % or more, and 99 mass % or more, and the resin constituting the heat seal layer (D) may be composed only of the ethylene-α-olefin copolymer resin (d). In addition, the ratio of the ethylene-α-olefin copolymer resin (d) in the heat seal layer (D) is preferably 60 mass % or more, more preferably 80 mass % or more, and even more preferably 90 mass % or more, and may be 95 mass % or more, 97 mass % or more, and 99 mass % or more, and the heat seal layer (D) may be substantially composed only of the ethylene-α-olefin copolymer resin (d).

The method of producing the resin composition constituting the heat seal layer (D) is not particularly limited, and the method allows production by melt kneading the ethylene-α-olefin copolymer resin (d) and, as needed, other additives, such as the higher fatty acid amide compound (e) and the inorganic oxide particles (f). The higher fatty acid amide compound (e) may be mixed directly in a solid state, such as a powder, or as a melt, or may be mixed as a solute to be contained in a solution or as a dispersoid contained in a dispersion. As the solution and the dispersion, aqueous solutions and aqueous dispersions are preferred, respectively. For melt kneading, it is possible to use a known mixing device or kneading device, such as a kneader ruder, an extruder, mixing rolls, and a Banbury mixer, for example. The temperature range during melt kneading may be adjusted appropriately in accordance with the melting point of the ethylene-α-olefin copolymer resin (d) to be used and the like, and the range from 150° C. to 300° C. is usually employed.

In another embodiment, a masterbatch containing a high concentration of other additives, such as the higher fatty acid amide compound (e) and the inorganic oxide particles (f), as needed with respect to the ethylene-α-olefin copolymer resin (d) may be produced by melt kneading and dry blended with the ethylene-α-olefin copolymer resin (d) containing substantially no other additives, such as the higher fatty acid amide compound (e) and the inorganic oxide particles (f), to be used for production of multilayer films. In still another embodiment, the ethylene-α-olefin copolymer resin (d) and other additives, such as the higher fatty acid amide compound (e) and the inorganic oxide particles (f), as needed may be dry blended to be used for production of multilayer films. Dry blending refers to mechanical mixing in the form of powder granules or pellets. Mixing may be performed using a mixing device, such as a tumbler, a ribbon mixer, and a Henschel mixer, or by manual stirring, shaking, and the like in a well-closed container. The mixing temperature may be from room temperature to below the melting point of the ethylene-α-olefin copolymer resin (d), and the mixing may be carried out in an air atmosphere or a nitrogen atmosphere.

### Multilayer Film

The multilayer film of the present invention has the barrier layer (A), the adhesive layer (B), the thermoplastic resin layer (C), and the heat seal layer (D), while having no layer containing a resin with a melting point of 200° C. or more as a main component and no metal layer with a thickness of 1 μm or more. Having no layer containing a resin with a melting point of 200° C. or more as a main component and no metal layer with a thickness of 1 μm or more allows inhibition of nonuniform mixing with other components during melt molding of the ground product of the multilayer film. It should be noted that the metal layer in this context refers to a layer made of metal, such as aluminum foil, and having continuous and discontinuous surfaces. In addition, at least a pair of the barrier layer (A) and the adhesive layer (B) are preferably laminated adjacent to each other. This allows production of a multilayer film that has high gas barrier properties and recyclability and also has excellent mechanical strength and stability of the same.

In the multilayer film of the present invention, when a temperature is risen from −50° C. to 220° C. at 10° C./min (first temperature rise) and then lowered to −50° C. at 10° C./min and further risen to 220° C. at 10° C./min (second temperature rise) using a differential scanning calorimeter (DSC), the ratio (H1/H2) of the total heat of fusion (H1) from 0° C. to 150° C. during the first temperature rise to the total heat of fusion (H2) from 0° C. to 150° C. during the second temperature rise is from 0.75 to 1.01. The ratio (H1/H2) of heat of fusion within the above range allows both mechanical strength and water vapor barrier properties to be obtained at a high level while keeping the total thickness low. From the perspective of further improving mechanical strength, the upper limit of the ratio (H1/H2) of heat of fusion is preferably 0.99, more preferably 0.97, and even more preferably 0.95. Meanwhile, from the perspective of improving the water vapor barrier properties of the multilayer film, the lower limit of the ratio (H1/H2) of heat of fusion is preferably 0.85, more preferably 0.90, and even more preferably 0.92. In this context, the total heat of fusion from 0° C. to 150° C. means the total heat of fusion of the resins with a melting point from 0° C. to 150° C. in the multilayer film, and in one embodiment of the present invention, means the total heat of fusion of the polyethylene-based resins, for example. The ratio (H1/H2) of heat of fusion may be controlled by the set temperatures of the extruder and the die while producing the multilayer film and by the cooling rate after being discharged from the die. When a T die is used (cast molding, etc.), the cooling rate after being discharged from the die may be controlled by the distance (air gap) or time to contact the first cooling roll after being discharged from the die or by the temperature of the cooling roll and the like, and it is particularly important to reduce the degree of crystallinity by rapid cooling. The temperature of the cooling roll is preferably from 35° C. to 75° C., more preferably 35° C. to 65° C., and even more preferably from 35° C. to 50° C. Meanwhile, when an annular die is used (inflation molding, blow molding, etc.), cooling methods are limited and rapid cooling is difficult, causing difficulty in satisfying the above ratio (H1/H2) of heat of fusion. In addition, in the case of heat treatment performed again after cooled once, the ratio (H1/H2) of heat of fusion may also be controlled by the temperature, time, and the like.

In the multilayer film of the present invention, when a temperature is risen from −50° C. to 220° C. at 10° C./min (first temperature rise) and then lowered to −50° C. at 10° C./min and further risen to 220° C. at 10° C./min (second temperature rise) using a differential scanning calorimeter (DSC), the ratio (H1/H2) of the total heat of fusion (H1) from 150° C. to 200° C. during the first temperature rise to the total heat of fusion (H2) from 150° C. to 200° C. during the second temperature rise is preferably from 0.90 to 1.35. The ratio (H1/H2) of heat of fusion within the above range allows both mechanical strength and oxygen barrier properties to be obtained at a higher level while keeping the total thickness low. From the perspective of further improving mechanical strength, the upper limit of the ratio (H1/H2) of heat of fusion is more preferably 1.30 and even more preferably 1.25. Meanwhile, from the perspective of improving the oxygen barrier properties of the multilayer film, the lower limit of the ratio (H1/H2) of heat of fusion is more preferably 1.00 and even more preferably 1.10. In this context, the total heat of fusion from 150° C. to 200° C. means the total heat of fusion of the resins with a melting point from 150° C. to 200° C. in the multilayer film, and in one embodiment of the present invention, means the total heat of fusion of the EVOH (a), for example. The ratio (H1/H2) of heat of fusion may be controlled by the set temperatures of the extruder and the die while producing the multilayer film and by the cooling rate after being discharged from the die. However, the barrier layer (A) containing the EVOH (a) is arranged between the at least one pair of the thermoplastic resin layer (C) and the heat seal layer (D), and thus is not readily influenced by, for example, the cooling roll. Accordingly, the cooling roll at a sufficiently low temperature is allowed to effectively cool the barrier layer (A) and thus facilitates more effective adjustment of the ratio (H1/H2) of heat of fusion within the above range. When a T die is used, the cooling rate after being discharged from the die may be controlled by the distance (air gap) or time to contact the first cooling roll after being discharged from the die or by the temperature of the cooling roll and the like, and it is particularly important to reduce the degree of crystallinity by rapid cooling. Meanwhile, when an annular die is used (inflation molding, blow molding, etc.), cooling methods are limited and rapid cooling is difficult, causing difficulty in satisfying the above ratio (H1/H2) of heat of fusion. In addition, in the case of heat treatment performed again after cooled once, the ratio (H1/H2) of heat of fusion may also be controlled by the temperature, time, and the like.

As the lamination method for producing the above multilayer film, it is possible to use conventional coextrusion methods in which the respective resins are extruded from separate dies or a common die and laminated. As the die, either an annular die or a T die may be used. The molding temperature during melt molding may be appropriately adjusted based on the melting point and melt viscosity of the resins to be used and is often selected from the range from 150° C. to 300° C.

The total thickness of the multilayer film of the present invention is preferably from 15 to 300 μm, more preferably 25 to 250 μm, even more preferably from 35 to 200 μm, and particularly preferably from 45 to 150 μm. The total thickness within the above range causes the multilayer film of the present invention to be lightweight and flexible and is therefore preferably used for flexible packaging applications. It also causes the amount of resin used in the multilayer film to be small and reduces environmental load.

The multilayer film of the present invention preferably has a ratio of the thickness of the barrier layer (A) to the total thickness of all layers of 0.10 or less. This ratio within the above range improves recyclability and mechanical strength. The upper limit of the ratio of the thickness of the barrier layer (A) to the total thickness of all layers is more preferably 0.08 or less, even more preferably 0.05 or less, and particularly preferably 0.04 or less. The lower limit of the ratio of the thickness of the barrier layer (A) to the total thickness of all layers is generally, but not particularly limited to, 0.005 or more in order to exhibit sufficient gas barrier properties. Meanwhile, the multilayer film of the present invention preferably has a ratio of the thickness of the thermoplastic resin layer (C) to the total thickness of all layers of 0.20 or more and 0.60 or less. This ratio within the above range improves water vapor barrier properties of the multilayer film. In addition, the multilayer film of the present invention preferably has a sum total of the ratio of the thickness of the thermoplastic resin layer (C) and the ratio of the thickness of the heat seal layer (D) to the total thickness of all layers of 0.60 or more, more preferably 0.70 or more, and even more preferably 0.80 or more. This ratio within the above range improves recyclability, mechanical strength and water vapor barrier properties.

The layer structure of the multilayer film of the present invention is not particularly limited as long as the barrier layer (A) is between at least a pair of the thermoplastic resin layer (C) and the thermoplastic resin layer (D). Where the thermoplastic resin layer (C) is expressed as (C), the adhesive resin layer (B) as (B (B1 or B2)), the barrier layer (A) as (A), and the heat seal layer (D) as (D), and “/” indicates direct lamination, examples of the layer structure include (C)/(B1)/(A)/(B2)/(D), (C)/(D)/(B2)/(A)/(B2)/(D), and the like. In addition to the above layer structures, the film may have still another layer and the other layer may be in the outermost layer or between the respective layers of the multilayer film. The multilayer film of the present invention having the barrier layer (A) between at least a pair of the thermoplastic resin layer (C) and the heat seal layer (D) allows efficient cooling after film formation of the thermoplastic resin layer (C) and the heat seal layer (D) and tends to allow the ratio (H1/H2) of the total heat of fusion from 0° C. to 150° C. to be relatively readily adjusted. Still in addition, in the case of using a plurality of barrier layers (A), adhesive layers (B), and heat seal layers (D), different kinds of each resin may be used. It should be noted that, when the thermoplastic resin layer (C) and the adhesive layer (B) are directly laminated, a relatively low acid value of the adhesive layer (B) tends to cause the resulting multilayer film to be excellent in appearance properties. Meanwhile, when the heat seal layer (D) and the adhesive layer (B) are directly laminated, the acid value of the adhesive layer (B) exerts relatively small influence on the appearance properties of the resulting multilayer film and acid values within a certain range provide excellent appearance properties. Yet in addition, from the perspective of allowing easier adjustment of the ratio (H1/H2) of the total heat of fusion from 0° C. to 150° C., it is preferable that one outermost layer is the thermoplastic resin layer (C) and the other outermost layer is the heat seal layer.

The oxygen transmission rate (OTR) of the multilayer film of the present invention under conditions of 20° C. and 65% RH may be adjusted depending on the application and is preferably, but not particularly limited to, 5 cc/(m²·day·atm) or less. The multilayer film with an OTR within this range is excellent in gas barrier properties and is preferably used as a packaging material. The OTR is more preferably 4 cc/(m²·day·atm) or less, even more preferably 3 cc/(m²·day·atm) or less, and particularly preferably 2 cc/(m²·day·atm) or less. The OTR is measured in accordance with JIS K 7126-2 (equal pressure method; 2006), and specifically, the method described in Examples is employed.

The water vapor transmission rate (WVTR) of the multilayer film of the present invention under conditions of 40° C. and 90% RH may be adjusted depending on the application and is preferably, but not particularly limited to, 4.5 g/(m²·day) or less. The multilayer film with a WVTR within this range is excellent in gas barrier properties and is preferably used as a packaging material. The WVTR is more preferably 4.0 g/(m²·day) or less, even more preferably 3.5 g/(m²·day) or less, and particularly preferably 3.0 g/(m²·day) or less. The WVTR is measured in accordance with JIS K 7129-2 (infrared sensor method; 2019), and specifically, the method described in Examples is employed.

The multilayer film of the present invention preferably has an elongation at break (puncture elongation at break) of 8.0 mm or more when humidity is conditioned for 24 hours under conditions of 23° C. and 50% RH and then a needle with a tip diameter of 1 mm pierces the multilayer film at a rate of 50 mm/min under the same conditions. The multilayer film with a puncture elongation at break within this range is excellent in mechanical strength and is less likely to break due to external impact and the like, and is thus preferably used as a packaging material. The puncture elongation is more preferably 9.0 mm or more, even more preferably 10.0 mm or more, and particularly preferably 11.0 mm or more. The puncture elongation may be 16.0 mm or less.

The multilayer film of the present invention preferably has a strength at break (puncture elongation at break) of 8.5 N or more when humidity is conditioned for 24 hours under conditions of 23° C. and 50% RH and then a needle with a tip diameter of 1 mm pierces at a rate of 50 mm/min under the same conditions. The multilayer film with a puncture strength within this range is excellent in mechanical strength and is less likely to break due to external impact and the like, and is thus preferably used as a packaging material. The puncture elongation is more preferably 9.0 N or more, even more preferably 10.0 N or more, and particularly preferably 10.5 N or more. The puncture strength may be 15.0 N or less.

The multilayer film of the present invention preferably has a coefficient of variation (value obtained by dividing the standard deviation by the average value) of the puncture strength at break of 0.05 or less. The multilayer film with a coefficient of variation within this range is excellent in mechanical strength stability and is less likely to break due to external impact and the like, and is thus preferably used as a packaging material. The coefficient of variation is more preferably 0.03 or less, even more preferably 0.015 or less, and particularly preferably 0.010 or less.

### Multilayer Structure

While the multilayer film of the present invention itself can be used as a packaging material with gas barrier properties, the multilayer film may be further laminated with at least one resin layer (R) containing a thermoplastic resin (h) as a main component to form a multilayer structure to provide various functions as a packaging material, such as thermal resistance and design properties. The thermoplastic resin (h) is not particularly limited and examples include: homo- and co-polymers of olefins, such as linear low-density polyethylene, low density polyethylene, medium density polyethylene, high density polyethylene, vinyl ester resins, ethylene-propylene copolymers, polypropylene, propylene-α-olefin copolymers (α-olefins with a carbon number from 4 to 20), polybutene, and polypentene; polyamides, such as nylon 6 and nylon 6,6; polyesters, such as polyethylene terephthalate, polybutylene terephthalate, and polyethylene naphthalate; polystyrenes; polyvinyl chlorides; polyvinylidene chlorides; acrylic resins; polycarbonates; chlorinated polyethylenes; chlorinated polypropylenes; and the like. Among them, polyolefins are preferred from the perspective of excellent moisture resistance, mechanical properties, heat sealability, economic efficiency, and the like, and polyamides and polyesters are preferred from the perspective of excellent mechanical properties, thermal resistance, and the like. In particular, to obtain a multilayer structure excellent in recyclability, the thermoplastic resin (h) more preferably contains a polyethylene resin as a main component and is even more preferably a polyethylene resin. Such a resin layer (R) may be a monolayer or a multilayer composed of a plurality of layers. In addition, the resin layer (R) may be unstretched or may be uniaxially or biaxially stretched or rolled. The resin layer (R) is preferably a biaxially oriented layer from the perspective of improving mechanical strength and preferably an unoriented layer from the perspective of improving heat sealability.

Although the method of forming the resin layer (R) is not particularly limited, it is generally formed by melt extrusion using an extruder. As the die, either an annular die or a T die may be used. The method of uniaxial or biaxial stretching is not particularly limited, either, and may be produced by stretching in the direction of the film flow and/or in a direction orthogonal to the flow direction, that is, in the width direction using a conventionally known stretching method, such as roll-type uniaxial stretching, simultaneous tubular-type biaxial stretching, sequential tenter-type biaxial stretching, and simultaneous tenter-type biaxial stretching. The draw ratio is preferably from 8 to 60 times the area ratio from the perspective of the uniformity of the thickness and the mechanical strength of the layer to be obtained. The area ratio is more preferably 55 or less times and even more preferably 50 or less times. In addition, the area ratio is more preferably 9 or more times. An area ratio of less than 8 times sometimes causes stretching unevenness to remain, and an area ratio of more than 60 times sometimes causes the layer to be easily broken during stretch.

The resin layer (R) preferably has a thickness from 10 to 200 μm from the perspective of industrial productivity. Specifically, the thickness in the case of an unoriented layer is more preferably from 10 to 150 μm, and the thickness in the case of a biaxially oriented layer is more preferably from 10 to 50 μm.

In addition, the multilayer structure of the present invention preferably has the total thickness of 300 μm or less and may be 25 μm or more. The total thickness within the above range causes the multilayer structure of the present invention to be lightweight and flexible while maintaining good mechanical properties and gas barrier properties, and is thus preferably used for flexible packaging applications. It also causes the amount of resin used in the multilayer structure to be small and reduces environmental load.

While the thickness of each layer in the multilayer structure of the present invention may be appropriately adjusted depending on the application, the ratio of the total thickness of the layers containing polyethylene resins (the resin layer (R), the adhesive layer (B), the thermoplastic resin layer (C), and the heat seal layer (D)) as a main component to the total thickness of the multilayer structure is preferably 0.80 or more, more preferably 0.85 or more, even more preferably 0.90 or more, and particularly preferably 0.95 or more from the perspective of allowing inhibition of coloration during melt molding of the ground product, improving thermal stability during melt molding, and inhibiting generation of hard spots.

The multilayer structure of the present invention preferably has no layer containing a resin with a melting point of 200° C. or more as a main component and no metal layer with a thickness of 1 μm or more. Having no layer containing a resin with a melting point of 200° C. or more as a main component and no metal layer with a thickness of 1 μm or more allows inhibition of nonuniform mixing with other components while melt molding the ground product of the multilayer structure. It should be noted that the metal layer in this context refers to a layer made of metal, such as aluminum foil, and having continuous and discontinuous surfaces.

The method of laminating the resin layer (R) on the multilayer film of the present invention is not particularly limited, and examples include extrusion lamination, coextrusion lamination, dry lamination, and the like. For laminating the resin layer (R) on the multilayer film, an adhesive layer may be provided. The adhesive layer may be formed using the adhesive layer (B) or by coating with a known adhesive and drying the adhesive. The adhesive is preferably a two-component reactive polyurethane-based adhesive in which a polyisocyanate component and a polyol component are mixed and reacted. The thickness of the adhesive layer is preferably, but not particularly limited to, from 1 to 5 μm and more preferably from 2 to 4 μm.

The multilayer structure of the present invention may have layers other than those described above as long as the effects of the present invention are not impaired. Examples of such another layer include recycled layers. In particular, it is preferable to reuse a recycled composition containing a recycled material, described later, from the multilayer film or the multilayer structure of the present invention as part or all of the recycled layer. Other examples of such another layer include printed layers. Such a printed layer may be included in any position in the multilayer structure of the present invention. An example of the printed layer includes a film obtained by coating with a solution containing pigments or dyes and, as needed, a binder resin and drying the solution. Examples of the method of coating with the printed layer include gravure printing as well as various coating methods using a wire bar, a spin coater, a die coater, and the like. The thickness of the printed layer is preferably, but not particularly limited to, from 0.5 to 10 μm and more preferably from 1 to 4 μm.

Offcuts and defective products generated during the production of the multilayer film or the multilayer structure of the present invention are preferably collected and reused. It is also a preferred embodiment to collect and reuse multilayer films and multilayer structures distributed in the market. Preferred embodiments of the present invention also include: a method of recycling a multilayer film or multilayer structure comprising grinding the multilayer film or the multilayer structure of the present invention, followed by melt molding; and a recycled composition containing a recycled material from the multilayer film or the multilayer structure of the present invention. In this context, the recycled material from the multilayer film or the multilayer structure of the present invention also includes a recycled material from packaging materials containing the multilayer film or the multilayer structure of the present invention.

For recycling the multilayer film and multilayer structure of the present invention, at first, a material collected from the multilayer film and the multilayer structure of the present invention is ground. The ground material may be directly melt molded to obtain a recycled composition or may be melt molded together with other components as needed to obtain a recycled composition. Preferred examples of the component to be added to the collected material include polyolefin resins, and polyethylene resins are more preferable. The ground collected material may be directly used for the production of molded articles, such as multilayer structures, or the ground collected material may be melted and pelletized to obtain pellets made of the recycled composition and then use the pellets for production of molded articles. Examples of the method of melt molding the recycled composition include extrusion molding, inflation extrusion, blow molding, melt spinning, and injection molding. The molding temperature during melt molding may be appropriately adjusted based on the melting point and melt viscosity of the resins to be used and is often selected from the range from 150° C. to 300° C. The recycled composition may contain unused resin while the content of the recycled material in the recycled composition is preferably 10 mass % or more and more preferably 20 mass % or more, and may be 30 mass % or more. In addition, the content of the EVOH (a) in the recycled composition is preferably 20 mass % or less and more preferably 10 mass % or less and may be 5 mass % or less.

The multilayer structure of the present invention is excellent in appearance properties, gas barrier properties, mechanical properties, and recyclability and thus may be preferably used as a material for various packaging, such as food packaging, pharmaceutical packaging, industrial chemical packaging, and agricultural chemical packaging, while the multilayer structure may also be used in even wider range of applications and is not limited to these applications.

A preferred embodiment of the packaging material is a package formed by filling the packaging material with contents. Contents allowed to be filled include, but not limited to: beverages, such as wine and fruit juice; foods, such as fruits, nuts, vegetables, meat products, infant foods, coffee, jam, mayonnaise, ketchup, cooking oil, dressings, sauces, Tsukudani (food boiled in soy sauce), and dairy products; others, such as pharmaceuticals, cosmetics, gasoline, and other contents that readily degrade in the presence of oxygen.

### EXAMPLES

The present invention is even more specifically described below with reference to Examples while the present invention is not at all limited by Examples below.

### Materials Used

Adhesive resin (b)
b-1: Maleic anhydride-modified polyethylene “ADMER™ NF518” produced by Mitsui Chemicals, Inc. (MFR (190° C., under a load of 2.16 kg) 3.1 g/10 min, density 0.91 g/cm³, acid value 1.10 mg KOH/g)
b-2: Maleic anhydride-modified polyethylene “BYNEL™ 41E687” produced by Dow Chemical Co. (MFR (190° C., under a load of 2.16 kg) 1.7 g/10 min, density 0.91 g/cm³, acid value 2.75 mg KOH/g)
b-3: Dry blend of linear low-density polyethylene (d-1) described below with maleic anhydride-modified polyethylene produced by Dow Chemical Co. “Bynel™ 41E710” (MFR (190° C., under a load of 2.16 kg) 1.7 g/10 min, density 0.91 g/cm³, acid value 10.7 mg KOH/g) at a mass ratio of 85/15 (average acid value 1.6 mg KOH/g)
Polyethylene-based resin (c)
c-1: High density polyethylene “NOVATEC™ HD HY540” produced by Japan Polyethylene Corp. (MFR (190° C., under a load of 2.16 kg) 1.0 g/10 min, density 0.960 g/cm³)
c-2: High density polyethylene “HI-ZEX™ 3300F” produced by Prime Polymer Co., Ltd. (MFR (190° C., under a load of 2.16 kg) 1.1 g/10 min, density 0.949 g/cm³)
Ethylene-α-olefin copolymer resin (d)
d-1: Linear low-density polyethylene produced by Dow Chemical Co. “Elite™ AT6101” (ethylene and 1-octene polymerized with metallocene catalyst, MFR (190° C., under a load of 2.16 kg) 0.8 g/10 min, density 0.905 g/cm³, heat of fusion at 100° C. or less 69.2 J/g, heat of fusion at 100° C. or more 17.6 J/g, total heat of fusion 86.8 J/g, ratio of heat of fusion at 100° C. or less 79.7%)
d-2: Linear low-density polyethylene “Evolue™ SP0510” produced by Prime Polymer Co., Ltd. (ethylene and 1-hexene polymerized with metallocene catalyst, MFR (190° C., under a load of 2.16 kg) 1.2 g/10 min, density 0.903 g/cm³, heat of fusion at 100° C. or less 61.6 J/g, heat of fusion at 100° C. or more 20.9 J/g, total heat of fusion 82.5 J/g, ratio of heat of fusion at 100° C. or less 74.7%)
d-3: Low density polyethylene “NOVATEC™ LD LJ400” produced by Japan Polyethylene Corp. (not ethylene-α-olefin copolymer, MFR (190° C., under a load of 2.16 kg) 1.5 g/10 min, density 0.921 g/cm³, heat of fusion at 100° C. or less 51.7 J/g, heat of fusion at 100° C. or more 59.5 J/g, total heat of fusion 111.2 J/g, ratio of heat of fusion at 100° C. or less 46.5%)
d-4: Linear low-density polyethylene “INNATE™ TH60” produced by Dow Chemical Co. (polymerized ethylene and 1-octene, MFR (190° C., under a load of 2.16 kg) 0.85 g/10 min, density 0.912 g/cm³, heat of fusion at 100° C. or less 30.5 J/g, heat of fusion at 100° C. or more 56.2 J/g, total heat of fusion 86.7 J/g, ratio of heat of fusion at 100° C. or less 35.2%)

In d-1 through d-4, the heat of fusion at 100° C. or less, the heat of fusion at 100° C. or more, the total heat of fusion, and the ratio of the heat of fusion at 100° C. or less were calculated from the melting curve when the temperature was risen from 20° C. to 250° C. at the rate of 10° C./min using a differential scanning calorimeter DSC (“Q 2000” manufactured by TA Instruments).
Higher fatty acid amide compound (e)
S1A: Stearic acid amide (melting point 101° C.)
O1A: Oleic acid amide (melting point 72° C.)
Polyvalent metal ion (g)
Mg-St: Magnesium stearate
Ca-St: Calcium stearate
Zn-St: Zinc stearate
MgOAc: Magnesium acetate
Alkali metal ion
AcONa: Sodium acetate
AcOK: Potassium acetate

### Evaluation Method

### (1) Analysis of Heat of Fusion

For the multilayer films obtained in Examples and Comparative Examples, when the temperature was risen from −50° C. to 220° C. at 10° C./min (first temperature rise) and then lowered to −50° C. at 10° C./min and further risen to 220° C. at 10° C./min (second temperature rise) using a differential scanning calorimeter DSC (“Q 2000” manufactured by TA Instruments), the ratio (H1/H2) of the total heat of fusion (H1) from 0° C. to 150° C. during the first temperature rise to the total heat of fusion (H2) from 0° C. to 150° C. during the second temperature rise was calculated.

### (2) Evaluation of Appearance Properties

The multilayer films obtained in Examples and Comparative Examples were visually evaluated and assessed using the following criteria. It should be noted that E1 through E3 are unacceptable criteria.

### Assessment: Criteria

A: Uniform appearance in good condition with no coloration
B1: Observed very slight defects, such as hard spots
B2: Observed very slight coloration (yellowing)
B3: Observed very slight unevenness (thickness, bleed out)
C1: Observed slight defects, such as hard spots
C2: Observed slight coloration (yellowing)
C3: Observed slight unevenness (thickness, bleed out)
D1: Observed moderate defects, such as hard spots
D2: Observed moderate discoloration (yellowing)
D3: Observed moderate unevenness (thickness, bleed out)
E1: Observed severe defects, such as hard spots
E2: Observed severe coloration (yellowing)
E3: Observed severe unevenness (thickness, bleed out)

### (3) Measurement of Oxygen Transmission Rate

Using the multilayer films obtained in Examples and Comparative Examples, the oxygen transmission rate was measured using one side as the oxygen supply side and the other side as the carrier gas side. Specifically, using an oxygen transmission rate analyzer (“MOCON OX-TRAN 2/21” manufactured by Modern Control Inc.), the oxygen transmission rate (unit: cc/(m²·day·atm)) was measured under conditions of the temperature of 20° C., the humidity of 65% RH on the oxygen supply side, the humidity of 65% RH on the carrier gas side, the oxygen pressure of 1 atm, and the carrier gas pressure of 1 atm in accordance with JIS K 7126-2 (equal pressure method; 2006). As the carrier gas, nitrogen gas containing 2 vol % hydrogen gas was used.

### (4) Measurement of Water Vapor Permeation Rate

Using the multilayer films obtained in Examples and Comparative Examples, the water vapor transmission rate was measured using one side as the water vapor supply side and the other side as the carrier gas side. Specifically, using a water vapor transmission rate analyzer (“MOCON PERMATRAN W3/33” manufactured by Modern Control Inc.), the oxygen transmission rate (unit: g/(m²·day)) was measured under conditions of the temperature of 40° C., the humidity of 90% RH on the water vapor supply side, the humidity of 0% RH on the carrier gas side, the oxygen pressure of 1 atm, and the carrier gas pressure of 1 atm in accordance with JIS K 7129-2 (infrared sensor method; 2019). As the carrier gas, nitrogen gas was used. If the water vapor transmission rate was 4.5 g/(m²·day) or more, determination was made that the water vapor barrier properties were insufficient.

### (5) Measurement of Puncture Strength and Elongation at Break

The multilayer films obtained in Examples and Comparative Examples were humidity conditioned for 24 hours under conditions of 23° C. and 50% RH and then a needle with a tip diameter of 1 mm pierced at the rate of 50 mm/min under the same conditions to measure the elongation at break and the strength at break. The measurement was performed 10 times at different spots, and the average value was employed as the measurement result. If the puncture elongation at break was less than 8.0 mm, determination was made that the mechanical properties were insufficient. In addition, if the puncture strength at break was less than 8.5 N, determination was made that the mechanical properties were insufficient.

### (6) Evaluation of Drop Resistance of Bags to Breakage

The multilayer films obtained in Examples and Comparative Examples were cut into two A4 size sheets, laid on each other, and heat sealed on three sides in a width of 5 mm. Then, 1 L of water was filled from the opening, and the remaining side was heat sealed to create a water-filled bag. This water-filled bag was caused to fall freely in an upright direction from a height of 1 m under conditions of 20° C. and 70% RH. The bag was dropped 20 times, and those with no leakage of water and no delamination observed were assessed as passed, and those with leakage or delamination observed were assessed as failed. The same test was performed 5 times, and the assessment was made using the following criteria. It should be noted that C is an unacceptable criterion.

### Assessment: Criteria

A: Passed all 5 times
B: Passed 4 out of 5 times, failed once
C: Faild 2 or more times

### (7) Hard Spots and Coloration in Melt Molded Product of Ground Product of Multilayer Film

The multilayer films obtained in Examples and Comparative Examples were ground to a size of 4 mm square or less. The ground product was mixed with a low density polyethylene resin produced by Japan Polyethylene Corp. “NOVATEC LD LJ400” (MFR (190° C., under a load of 2.16 kg) 1.5 g/10 min, density 0.921 g/cm³) at a mass ratio (ground product/polyethylene resin) of 40/60 and monolayer film formation was performed under the extrusion conditions indicated below to obtain a monolayer film with a thickness of 50 μm. The thickness of the monolayer film was adjusted by appropriately changing the number of screw rotations and the rate of the take-up roll. In addition, as a control, a monolayer film with a thickness of 50 μm was obtained in the same manner using only a polyethylene resin.
Extruder: Single screw extruder manufactured by Toyo Seiki Seisaku-sho, Ltd.
Screw diameter: 20 mmφ (L/D=20, compression ratio=3.5, full flight type)
Extrusion temperature: Feeding section/Compression section/Measurement section/Die=180° C./230° C./230° C./230° C.
Take-up roll temperature: 80° C.

The state of hard spots and coloration in the monolayer films thus obtained was evaluated on the following five scales of A through E. It should be noted that E is an unacceptable criterion.

### Assessment Criteria for Hard Spots

A: Amount of hard spots almost the same compared to the control
B: Slightly more amount of small hard spots compared with the control
C: More amount of small hard spots compared with the control
D: More amount of large hard spots compared with the control
E: Much more amount of large hard spots compared with the control

### Assessment Criteria for Coloration

A: Small degree of hue change compared to the control
B: Slight coloration observed compared with the control
C: Moderate coloration observed compared with the control
D: Marked coloration observed compared with the control
E: Marked coloration observed and unevenness also observed compared with the control

### (8) Melt Viscosity Stability of Ground Product of Multilayer Film

The multilayer films obtained in Examples and Comparative Examples were ground to a size of 4 mm square or less. The change in torque was measured when 60 g of this ground product was kneaded using a Labo Plastomill (twin screw, counterdirectional) in a nitrogen atmosphere under conditions of 230° C. and 100 rpm. The torque values (TI and TF, respectively) minutes and 90 minutes after the start of kneading were calculated, and the ratio (TF/TI) of the values was used for evaluation on the following 5 scales of A through E. It should be noted that E is an unacceptable criterion.

### Assessment Criteria

A: 80/100 or more and less than 120/100
B: 70/100 or more and less than 80/100, or 120/100 or more and less than 130/100
C: 60/100 or more and less than 70/100, or 130/100 or more and less than 140/100
D: 50/100 or more and less than 60/100, or 140/100 or more and less than 150/100
E: Less than 50/100, or 150/100 or more

### EXAMPLES

### Example 1

Hydrated pellets of EVOH (a-1) (ethylene unit content 32 mol %, degree of saponification 99.9 mol %, MFR in the dry state (190° C., under a load of 2.16 kg) 1.6 g/10 min) were immersed in an aqueous solution containing sodium acetate, phosphoric acid, and boric acid at 25° C. for 6 hours with stirring, followed by deliquoring and drying in a hot air dryer (“DN 6101” manufactured by Yamato Scientific Co., Ltd.) at 80° C. for 4 hours and then drying at 120° C. for 40 hours to obtain dry EVOH pellets (water content 0.25%). It should be noted that the concentrations of sodium acetate, phosphoric acid, and boric acid were prepared to have the contents in the dry EVOH pellets thus obtained of 200 ppm of sodium acetate in terms of sodium ions, 30 ppm of phosphate ions in terms of phosphate radicals, and 150 ppm of boric acid in terms of boron elements. The dry EVOH pellets thus obtained and magnesium stearate were melt kneaded in such a manner that the content of magnesium ions in the resin composition thus obtained was 50 ppm to obtain resin composition pellets for the barrier layer (A). For melt kneading, a twin screw extruder manufactured by Toyo Seiki Seisaku-sho, Ltd. (D (mm)=25, L/D=30, screws: codirectional, fully intermeshing type) was used, and the resin temperature was adjusted to 220° C.

Linear low-density polyethylene (d-1) “Elite™ AT6101” pellets and stearic acid amide (S1A) (melting point 101° C.) were melt kneaded in such a manner that the content of stearic acid amide in the resin composition to be obtained was 4 mass % to produce stearic acid amide masterbatch pellets. For melt-kneading, a twin screw extruder manufactured by Toyo Seiki Seisaku-sho, Ltd. (D (mm)=25, L/D=30, screws: codirectional, fully intermeshing type) was used, and the resin temperature was adjusted to 220° C. Then, the linear low-density polyethylene (d-1) pellets and the stearic acid amide masterbatch pellets thus obtained were dry blended at a mass ratio of 98/2 to obtain resin composition pellets for the heat seal layer (D).

The resin composition pellets for the barrier layer (A) obtained as above, the maleic anhydride-modified polyethylene (b-1) produced by Mitsui Chemicals, Inc. used for the adhesive layer (B), and the HDPE (c-1) produced by Japan Polyethylene Corp. used for the thermoplastic resin layer (C), and the resin composition pellets for the heat seal layer (D) obtained as above were used to produce a multilayer film with a layer thickness and a layer structure of (C)/(B1)/(A)/(B2)/(D)=51 μm/6 μm/6 μm/6 μm/51 μm using a 5-layer coextrusion cast film formation facility with a width of 300 mm. The film forming conditions in this procedure are indicated below.
Extrusion temperature of barrier layer (A): Feeding Section/Compression Section/Measurement Section/Die=170° C./220° C./220° C./220° C.
Extrusion temperature of adhesive layers (B1) and (B2): Feeding Section/Compression Section/Measurement Section/Die=170° C./220° C./220° C./220° C.
Extrusion temperature of thermoplastic resin layer (C): Feeding Section/Compression Section/Measurement Section/Die=170° C./220° C./220° C./220° C.
Extrusion temperature of heat seal layer (D): Feeding section/Compression Section/Measurement Section/Die=170° C./220° C./220° C./220° C.
Distance (air gap) from die to cooling roll: 7 cm
Cooling roll temperature: 40° C.
Take-up speed: 1.5 m/min

The multilayer film thus obtained was subjected to heat of fusion analysis, evaluation of appearance properties, oxygen transmission rate, water vapor transmission rate, puncture strength and elongation at break, drop resistance of bags to breakage, hard spots and coloration in a melt molded product of the ground product of the multilayer film, and melt viscosity stability of the ground product of the multilayer film in accordance with the methods described above in the evaluation methods (1) through (8). The results are shown in Table 3.

A two-component reactive polyurethane-based adhesive (24 parts by mass of “TAKELAC A-520” and 4 parts by mass of “TAKENATE A-50” produced by Mitsui Chemicals, Inc.) was mixed with 37 parts by mass of ethyl acetate to prepare an adhesive solution. Then, the adhesive solution was coated on a uniaxially oriented polyethylene film (resin layer (R)) with a thickness of 25 μm using a bar coater so as to have the thickness after drying of 2 μm, and dried at 100° C. for 5 minutes, and then laminated on the multilayer film obtained as above to produce a multilayer structure with a layer thickness and a layer structure of (R)/Adhesive/(C)/(B1)/(A)/(B2)/(D)=25 μm/2 μm/51 μm/6 μm/6 μm/6 μm/51 μm. The multilayer structure thus obtained was firm yet flexible and was excellent in all of appearance properties, barrier properties (oxygen transmission rate, water vapor transmission rate), and mechanical properties, and thus may be preferably used as a packaging material. In addition, since the ratio of polyethylene-based materials was more than 0.9, it is also preferably used for recycling as a so-called mono-material packaging material.

### Examples 2-8, 10-24, 26, 29-32, Comparative Examples 1-3, 6, 7

A multilayer film was produced in the same manner as that in Example 1 using the kind of EVOH, the kind and content of polyvalent metal ions, the kind and content of alkali metal ions, the kind of adhesive resin (b), the kind of polyethylene-based resin (c), the kind of ethylene-α-olefin copolymer resin (d), and the kind and content of higher fatty acid amide compound (e) as shown in Table 1 or Table 2 except for changing the die temperature, the distance (air gap) from the die to the cooling roll, and the cooling roll temperature during multilayer film production as shown in Table 3 or Table 4 for the various kinds of measurement and evaluation. It should be noted that, in Examples 4 and 5, a cooling treatment was performed in which cold air at 10° C. was blown onto the surface of the thermoplastic resin layer (C) in the air gap. The results are shown in Table 3 or Table 4.

### Example 9

Dry EVOH pellets were prepared in the same manner as in Example 1 except for using the EVOH (a-4) (ethylene unit content 44 mol %, degree of saponification 99.9 mol %, MFR in the dry state (190° C., under a load of 2.16 kg) 1.7 g/10 min) instead of the EVOH (a-1). A multilayer film was prepared in the same manner as that in Example 1 except for melt kneading 20 parts by mass of the dry EVOH pellets thus obtained, 80 parts by mass of the dry EVOH pellets obtained in Example 1, and magnesium stearate so as to have the content of magnesium ions of 50 ppm in the resin composition to be obtained. produced a multilayer film in the same manner as in Example 1 for the various kinds of measurement and evaluation. The results are shown in Table 3 or Table 4.

### Example 25

A multilayer film was prepared in the same manner as that in Example 1 except for adding 10 mass % of spherical silica particles with an average particle diameter of 3.9 μm together with stearic acid amide during production of stearic acid amide masterbatch pellets for the various kinds of measurement and evaluation. The results are shown in Table 3 or Table 4. The multilayer film in this Example was excellent in slip properties on the film surface and had good handleability compared with the multilayer film in Example 1.

### Example 27, Comparative Example 10

A multilayer film was produced in the same manner as in Example 1 except for changing the film forming device used for multilayer film formation to a 6-layer coextrusion multilayer cast film forming device with a width of 300 mm to produce a multilayer film with a layer structure and a layer thickness of (C)/(D)/(B 2)/(A)/(B2)/(D)=19 μm/32 μm/6 μm/6 μm/6 μm/51 μm and for changing the cooling roll temperature as shown in Table 3 or Table 4 for the various kinds of measurement and evaluation. The results are shown in Table 3 or Table 4.

### Example 28

A multilayer film was produced in the same manner as in Example 1 except for changing the film forming device used for multilayer film formation to a 6-layer coextrusion multilayer cast film forming device with a width of 300 mm to produce a multilayer film with a layer structure and a layer thickness of (C)/(D)/(B 2)/(A)/(B2)/(D)=34 μm/17 μm/6 μm/6 μm/6 μm/51 μm for the various kinds of measurement and evaluation. The results are shown in Table 3 or Table 4.

### Example 33

A multilayer film was produced in the same manner as in Example 1 except for changing the layer structure and the layer thickness of the multilayer film to be produced to (C)/(B1)/(A)/(B2)/(D)=55.5 μm/3 μm/3 μm/3 μm/55.5 μm for the various kinds of measurement and evaluation. The results are shown in Table 3 or Table 4.

### Comparative Examples 4 and 5

A multilayer film was produced in the same manner as in Example 1 except for using the heat seal layer (D) instead of the thermoplastic resin layer (C) and changing the cooling roll temperature as shown in Table 3 or Table 4 to produce a multilayer film with a layer thickness and a layer structure of (D)/(B 2)/(A)/(B2)/(D)=51 μm/6 μm/6 μm/6 μm/51 μm for the various kinds of measurement and evaluation. The results are shown in Table 3 or Table 4.

### Comparative Examples 8 and 9

A multilayer film was produced in the same manner as in Example 1 except for using the thermoplastic resin layer (C) instead of the heat seal layer (D) and changing the cooling roll temperature as shown in Table 3 or Table 4 to produce a multilayer film with a layer thickness and a layer structure of (C)/(B 1)/(A)/(B1)/(C)=51 μm/6 μm/6 μm/6 μm/51 μm for the various kinds of measurement and evaluation. The results are shown in Table 3 or Table 4.

TABLE 1

| | Barrier Layer (A) | | | | | | | Adhesive Layer (B) | | | |
|---|---|---|---|---|---|---|---|---|---|---|---|
| | EVOH (a) | | | Polyvalent Metal Ion | | | | | | | |
| | | Ethylene Unit | | (g) | | Alkali Metal Ion | | Adhesive Resin (b1) | | Adhesive Resin (b2) | |
| | Kind | Content | MFR | Kind | Content | Kind | Content | Kind | Acid Value | Kind | Acid Value |
| | — | mol % | g/10 min | — | ppm | — | ppm | — | mg KOH/g | — | mg KOH/g |
| Example 1 | a-1 | 32 | 1.6 | Mg-St | 50 | AcONa | 200 | b-1 | 1.10 | b-1 | 1.10 |
| Example 2 | a-1 | 32 | 1.6 | Mg-St | 50 | AcONa | 200 | b-1 | 1.10 | b-1 | 1.10 |
| Example 3 | a-1 | 32 | 1.6 | Mg-St | 50 | AcONa | 200 | b-1 | 1.10 | b-1 | 1.10 |
| Example 4 | a-1 | 32 | 1.6 | Mg-St | 50 | AcONa | 200 | b-1 | 1.10 | b-1 | 1.10 |
| Example 5 | a-1 | 32 | 1.6 | Mg-St | 50 | AcONa | 200 | b-1 | 1.10 | b-1 | 1.10 |
| Example 6 | a-2 | 32 | 4.4 | Mg-St | 50 | AcONa | 200 | b-1 | 1.10 | b-1 | 1.10 |
| Example 7 | a-3 | 27 | 1.5 | Mg-St | 50 | AcONa | 200 | b-1 | 1.10 | b-1 | 1.10 |
| Example 8 | a-4 | 44 | 1.7 | Mg-St | 50 | AcONa | 200 | b-1 | 1.10 | b-1 | 1.10 |
| Example 9 | a-1 + a-4 | 32, 44 | xx | Mg-St | 50 | AcONa | 200 | b-1 | 1.10 | b-1 | 1.10 |
| Example 10 | a-1 | 32 | 1.6 | — | — | AcONa | 200 | b-1 | 1.10 | b-1 | 1.10 |
| Example 11 | a-1 | 32 | 1.6 | Mg-St | 50 | — | — | b-1 | 1.10 | b-1 | 1.10 |
| Example 12 | a-1 | 32 | 1.6 | — | — | — | — | b-1 | 1.10 | b-1 | 1.10 |
| Example 13 | a-1 | 32 | 1.6 | Mg-St | 15 | AcONa | 200 | b-1 | 1.10 | b-1 | 1.10 |
| Example 14 | a-1 | 32 | 1.6 | Mg-St | 150 | AcONa | 200 | b-1 | 1.10 | b-1 | 1.10 |
| Example 15 | a-1 | 32 | 1.6 | Mg-St | 50 | AcONa | 15 | b-1 | 1.10 | b-1 | 1.10 |
| Example 16 | a-1 | 32 | 1.6 | Mg-St | 50 | AcONa | 300 | b-1 | 1.10 | b-1 | 1.10 |
| Example 17 | a-1 | 32 | 1.6 | Ca-St | 50 | AcONa | 200 | b-1 | 1.10 | b-1 | 1.10 |
| Example 18 | a-1 | 32 | 1.6 | Zn-St | 50 | AcONa | 200 | b-1 | 1.10 | b-1 | 1.10 |
| Example 19 | a-1 | 32 | 1.6 | Mg-St | 50 | AcOK | 200 | b-1 | 1.10 | b-1 | 1.10 |
| Example 20 | a-1 | 32 | 1.6 | MgOAc | 50 | AcONa | 200 | b-1 | 1.10 | b-1 | 1.10 |
| Example 21 | a-1 | 32 | 1.6 | Mg-St | 50 | AcONa | 200 | b-2 | 2.75 | b-2 | 2.75 |
| Example 22 | a-1 | 32 | 1.6 | Mg-St | 50 | AcONa | 200 | b-3 | 1.6 | b-3 | 1.6 |

| | Thermoplastic Resin Layer (C) | | | Heat Seal Layer (D) | | | | | | |
|---|---|---|---|---|---|---|---|---|---|---|
| | Polyethylene- | | | Ethylene-α-Olefin | | Higher Fatty | | | | |
| | Based Resin | | Thermo-plastic | Copolymer Resin | | Acid Amide | | Inorganic Oxide Particle (f) | | |
| | (c) | | Resin Layer (C) | (d) | | Compound (e) | | | Average Particle | |
| | Kind | Density | Ratio | Kind | Density | Kind | Content | Kind | Diameter | Content |
| | — | g/cm³ | — | — | g/dm³ | — | ppm | — | μm | ppm |
| Example 1 | c-1 | 0.960 | 0.43 | d-1 | 0.905 | S1A | 800 | — | — | — |
| Example 2 | c-1 | 0.960 | 0.43 | d-1 | 0.905 | S1A | 800 | — | — | — |
| Example 3 | c-1 | 0.960 | 0.43 | d-1 | 0.905 | S1A | 800 | — | — | — |
| Example 4 | c-1 | 0.960 | 0.43 | d-1 | 0.905 | S1A | 800 | — | — | — |
| Example 5 | c-1 | 0.960 | 0.43 | d-1 | 0.905 | S1A | 800 | — | — | — |
| Example 6 | c-1 | 0.960 | 0.43 | d-1 | 0.905 | S1A | 800 | — | — | — |
| Example 7 | c-1 | 0.960 | 0.43 | d-1 | 0.905 | S1A | 800 | — | — | — |
| Example 8 | c-1 | 0.960 | 0.43 | d-1 | 0.905 | S1A | 800 | — | — | — |
| Example 9 | c-1 | 0.960 | 0.43 | d-1 | 0.905 | S1A | 800 | — | — | — |
| Example 10 | c-1 | 0.960 | 0.43 | d-1 | 0.905 | S1A | 800 | — | — | — |
| Example 11 | c-1 | 0.960 | 0.43 | d-1 | 0.905 | S1A | 800 | — | — | — |
| Example 12 | c-1 | 0.960 | 0.43 | d-1 | 0.905 | S1A | 800 | — | — | — |
| Example 13 | c-1 | 0.960 | 0.43 | d-1 | 0.905 | S1A | 800 | — | — | — |
| Example 14 | c-1 | 0.960 | 0.43 | d-1 | 0.905 | S1A | 800 | — | — | — |
| Example 15 | c-1 | 0.960 | 0.43 | d-1 | 0.905 | S1A | 800 | — | — | — |
| Example 16 | c-1 | 0.960 | 0.43 | d-1 | 0.905 | S1A | 800 | — | — | — |
| Example 17 | c-1 | 0.960 | 0.43 | d-1 | 0.905 | S1A | 800 | — | — | — |
| Example 18 | c-1 | 0.960 | 0.43 | d-1 | 0.905 | S1A | 800 | — | — | — |
| Example 19 | c-1 | 0.960 | 0.43 | d-1 | 0.905 | S1A | 800 | — | — | — |
| Example 20 | c-1 | 0.960 | 0.43 | d-1 | 0.905 | S1A | 800 | — | — | — |
| Example 21 | c-1 | 0.960 | 0.43 | d-1 | 0.905 | S1A | 800 | — | — | — |
| Example 22 | c-1 | 0.960 | 0.43 | d-1 | 0.905 | S1A | 800 | — | — | — |

TABLE 2

| | Barrier Layer (A) | | | | | | | | | | |
|---|---|---|---|---|---|---|---|---|---|---|---|
| | EVOH (a) | | | | | | | Adhesive Layer (B) | | | |
| | | Ethylene | | Polyvalent Metal Ion | | | | Adhesive Resin | | Adhesive Resin | |
| | | Unit | | (g) | | Alkali Metal Ion | | (b1) | | (b2) | |
| | Kind | Content | MFR | Kind | Content | Kind | Content | Kind | Acid Value | Kind | Acid Value |
| | — | mol % | g/10 min | — | ppm | — | ppm | — | mg KOH/g | — | mg KOH/g |
| Example 23 | a-1 | 32 | 1.6 | Mg-St | 50 | AcONa | 200 | b-1 | 1.10 | b-1 | 1.10 |
| Example 24 | a-1 | 32 | 1.6 | Mg-St | 50 | AcONa | 200 | b-1 | 1.10 | b-1 | 1.10 |
| Example 25 | a-1 | 32 | 1.6 | Mg-St | 50 | AcONa | 200 | b-1 | 1.10 | b-1 | 1.10 |
| Example 26 | a-1 | 32 | 1.6 | Mg-St | 50 | AcONa | 200 | b-1 | 1.10 | b-1 | 1.10 |
| Example 27 | a-1 | 32 | 1.6 | Mg-St | 50 | AcONa | 200 | — | — | b-1 | 1.10 |
| Example 28 | a-1 | 32 | 1.6 | Mg-St | 50 | AcONa | 200 | — | — | b-1 | 1.10 |
| Example 29 | a-1 | 32 | 1.6 | Mg-St | 50 | AcONa | 200 | b-2 | 2.75 | b-1 | 1.10 |
| Example 30 | a-1 | 32 | 1.6 | Mg-St | 50 | AcONa | 200 | b-1 | 1.1 | b-2 | 2.75 |
| Example 31 | a-1 | 32 | 1.6 | Mg-St | 50 | AcONa | 200 | b-1 | 1.10 | b-1 | 1.10 |
| Example 32 | a-1 | 32 | 1.6 | Mg-St | 50 | AcONa | 200 | b-1 | 1.10 | b-1 | 1.10 |
| Example 33 | a-1 | 32 | 1.6 | Mg-St | 50 | AcONa | 200 | b-1 | 1.10 | b-1 | 1.10 |
| Comparative | a-1 | 32 | 1.6 | Mg-St | 50 | AcONa | 200 | b-1 | 1.10 | b-1 | 1.10 |
| Example 1 | | | | | | | | | | | |
| Comparative | a-1 | 32 | 1.6 | Mg-St | 50 | AcONa | 200 | b-1 | 1.10 | b-1 | 1.10 |
| Example 2 | | | | | | | | | | | |
| Comparative | a-1 | 32 | 1.6 | Mg-St | 50 | AcONa | 200 | b-1 | 1.10 | b-1 | 1.10 |
| Example 3 | | | | | | | | | | | |
| Comparative | a-1 | 32 | 1.6 | Mg-St | 50 | AcONa | 200 | b-1 | 1.10 | b-1 | 1.10 |
| Example 4 | | | | | | | | | | | |
| Comparative | a-1 | 32 | 1.6 | Mg-St | 50 | AcONa | 200 | b-1 | 1.10 | b-1 | 1.10 |
| Example 5 | | | | | | | | | | | |
| Comparative | a-1 | 32 | 1.6 | Mg-St | 50 | AcONa | 200 | b-1 | 1.10 | b-1 | 1.10 |
| Example 6 | | | | | | | | | | | |
| Comparative | a-1 | 32 | 1.6 | Mg-St | 50 | AcONa | 200 | b-1 | 1.10 | b-1 | 1.10 |
| Example 7 | | | | | | | | | | | |
| Comparative | a-1 | 32 | 1.6 | Mg-St | 50 | AcONa | 200 | b-1 | 1.10 | b-1 | 1.10 |
| Example 8 | | | | | | | | | | | |
| Comparative | a-1 | 32 | 1.6 | Mg-St | 50 | AcONa | 200 | b-1 | 1.10 | b-1 | 1.10 |
| Example 9 | | | | | | | | | | | |
| Comparative | a-1 | 32 | 1.6 | Mg-St | 50 | AcONa | 200 | b-1 | 1.10 | b-1 | 1.10 |
| Example 10 | | | | | | | | | | | |

| | Thermoplastic Resin Layer (C) | | | Heat Seal Layer (D) | | | | | | |
|---|---|---|---|---|---|---|---|---|---|---|
| | | | Thermo- | Ethylene-α-Olefin | | | | Inorganic Oxide Particle (f) | | |
| | Polyethylene- | | plastic Resin | Copolymer Resin | | Higher Fatty Acid Amide | | | Average | |
| | Based Resin (c) | | Layer (C) | (d) | | Compound (e) | | | Particle | |
| | Kind | Density | Ratio | Kind | Density | Kind | Content | Kind | Diameter | Content |
| | — | g/cm³ | — | — | g/dm³ | — | ppm | — | μm | ppm |
| Example 23 | c-1 | 0.960 | 0.43 | d-1 | 0.905 | — | — | — | — | — |
| Example 24 | c-1 | 0.960 | 0.43 | d-1 | 0.905 | S1A, O1A | 400 + 400 | — | — | — |
| Example 25 | c-1 | 0.960 | 0.43 | d-1 | 0.905 | S1A | 800 | Spherical | 3.9 | 2000 |
| | | | | | | | | Silica | | |
| Example 26 | c-1 | 0.960 | 0.43 | d-2 | 0.903 | S1A | 800 | — | — | — |
| Example 27 | c-1 | 0.960 | 0.16 | d-1 | 0.905 | S1A | 800 | — | — | — |
| Example 28 | c-1 | 0.960 | 0.28 | d-1 | 0.905 | S1A | 800 | — | — | — |
| Example 29 | c-1 | 0.960 | 0.43 | d-1 | 0.905 | S1A | 800 | — | — | — |
| Example 30 | c-1 | 0.960 | 0.43 | d-1 | 0.905 | S1A | 800 | — | — | — |
| Example 31 | c-1 | 0.960 | 0.43 | d-4 | 0.912 | S1A | 800 | — | — | — |
| Example 32 | c-2 | 0.949 | 0.43 | d-1 | 0.905 | S1A | 800 | — | — | — |
| Example 33 | c-1 | 0.960 | 0.43 | d-1 | 0.905 | S1A | 800 | — | — | — |
| Comparative | c-1 | 0.960 | 0.43 | d-1 | 0.905 | S1A | 800 | — | — | — |
| Example 1 | | | | | | | | | | |
| Comparative | c-1 | 0.960 | 0.43 | d-1 | 0.905 | S1A | 800 | — | — | — |
| Example 2 | | | | | | | | | | |
| Comparative | c-1 | 0.960 | 0.43 | d-2 | 0.903 | S1A | 800 | — | — | — |
| Example 3 | | | | | | | | | | |
| Comparative | — | — | — | d-1 | 0.905 | S1A | 800 | — | — | — |
| Example 4 | | | | | | | | | | |
| Comparative | — | — | — | d-1 | 0.905 | S1A | 800 | — | — | — |
| Example 5 | | | | | | | | | | |
| Comparative | c-1 | 0.960 | 0.43 | d-3 | 0.921 | S1A | 800 | — | — | — |
| Example 6 | | | | | | | | | | |
| Comparative | c-1 | 0.960 | 0.43 | d-3 | 0.921 | S1A | 800 | — | — | — |
| Example 7 | | | | | | | | | | |
| Comparative | c-1 | 0.960 | 0.43 | — | — | S1A | 800 | — | — | — |
| Example 8 | | | | | | | | | | |
| Comparative | c-1 | 0.960 | 0.43 | — | — | S1A | 800 | — | — | — |
| Example 9 | | | | | | | | | | |
| Comparative | c-1 | 0.960 | 0.16 | d-1 | 0.905 | S1A | 800 | — | — | — |
| Example 10 | | | | | | | | | | |

TABLE 3

| | | | | Multilayer Film | | | |
|---|---|---|---|---|---|---|---|
| | | | | Heat of | Heat of | | |
| | | | | Fusion | Fusion | | |
| | | | | Ratio | Ratio | | |
| | Multilayer Film Formation Condition | | | (0° C.-150° | (150° C.-200° | | Oxygen |
| | | | Cooling Roll | C.) | C.) | Appearance | Transmission |
| | Die Temperature | Air Gap | Temperature | H1/H2 | H1/H2 | Property | Rate |
| | ° C. | cm | ° C. | — | — | — | cc/(m² · day · atm) |
| Example 1 | 220 | 7 | 40 | 0.96 | 1.23 | C1 | 1.2 |
| Example 2 | 220 | 7 | 60 | 0.98 | 1.32 | C1 | 1.2 |
| Example 3 | 220 | 7 | 70 | 1.00 | 1.33 | C1 | 1.2 |
| Example 4 | 220 | 7 (Cold Air) | 40 | 0.94 | 1.23 | C1 | 1.3 |
| Example 5 | 200 | 7 (Cold Air) | 40 | 0.93 | 1.23 | C1 | 1.5 |
| Example 6 | 220 | 7 | 40 | 0.96 | 1.23 | C1 | 1.2 |
| Example 7 | 220 | 7 | 40 | 0.96 | 1.23 | D1 | 0.7 |
| Example 8 | 220 | 7 | 40 | 0.96 | 1.23 | A | 4.7 |
| Example 9 | 220 | 7 | 40 | 0.96 | 1.23 | C1 | 1.2 |
| Example 10 | 220 | 7 | 40 | 0.96 | 1.23 | D1 | 1.2 |
| Example 11 | 220 | 7 | 40 | 0.96 | 1.23 | C1 | 1.2 |
| Example 12 | 220 | 7 | 40 | 0.96 | 1.23 | D1 | 1.2 |
| Example 13 | 220 | 7 | 40 | 0.96 | 1.23 | D1 | 1.2 |
| Example 14 | 220 | 7 | 40 | 0.96 | 1.23 | D2 | 1.2 |
| Example 15 | 220 | 7 | 40 | 0.96 | 1.23 | C1 | 1.2 |
| Example 16 | 220 | 7 | 40 | 0.96 | 1.23 | C1 | 1.2 |
| Example 17 | 220 | 7 | 40 | 0.96 | 1.23 | C1 | 1.2 |
| Example 18 | 220 | 7 | 40 | 0.96 | 1.23 | C1 | 1.2 |
| Example 19 | 220 | 7 | 40 | 0.96 | 1.23 | C1 | 1.2 |
| Example 20 | 220 | 7 | 40 | 0.96 | 1.23 | D1 | 1.2 |
| Example 21 | 220 | 7 | 40 | 0.96 | 1.23 | D1 | 1.2 |
| Example 22 | 220 | 7 | 40 | 0.96 | 1.23 | C1 | 1.2 |

| | Multilayer Film | | | | Melt Molded Product of | | |
|---|---|---|---|---|---|---|---|
| | Water Vapor | Puncture | Puncture | Drop | Multilayer Film Ground Product | | |
| | Transmission | Elongation | Strength | Bag | | | Viscosity |
| | Rate | at Break | at Break | Test | Hard Spot | Coloration | Stability |
| | g/(m² · day) | mm | N | — | — | — | — |
| Example 1 | 2.7 | 10.6 | 10.3 | A | B | B | B |
| Example 2 | 2.5 | 8.8 | 8.8 | A | B | B | B |
| Example 3 | 2.4 | 8.1 | 8.6 | A | B | B | B |
| Example 4 | 2.9 | 11.2 | 10.7 | A | B | B | B |
| Example 5 | 2.9 | 11.3 | 10.9 | A | B | B | B |
| Example 6 | 2.8 | 10.4 | 9.8 | A | A | B | B |
| Example 7 | 2.8 | 10.4 | 10.4 | A | C | C | C |
| Example 8 | 2.6 | 10.9 | 10.5 | A | B | A | A |
| Example 9 | 2.7 | 11.1 | 11.3 | A | B | B | B |
| Example 10 | 2.7 | 10.6 | 10.2 | A | D | B | D |
| Example 11 | 2.7 | 10.7 | 10.2 | B | C | B | C |
| Example 12 | 2.7 | 10.6 | 10.2 | B | D | B | D |
| Example 13 | 2.7 | 10.5 | 10.3 | A | C | B | C |
| Example 14 | 2.7 | 10.6 | 10.2 | A | C | D | D |
| Example 15 | 2.7 | 10.4 | 10.3 | B | B | B | B |
| Example 16 | 2.7 | 10.6 | 10.3 | A | C | D | C |
| Example 17 | 2.7 | 10.6 | 10.2 | A | B | B | C |
| Example 18 | 2.7 | 10.7 | 10.1 | A | C | B | C |
| Example 19 | 2.7 | 10.5 | 10.4 | A | B | C | B |
| Example 20 | 2.7 | 10.5 | 10.3 | A | C | C | C |
| Example 21 | 2.7 | 10.7 | 10.2 | A | B | B | B |
| Example 22 | 2.7 | 11.3 | 10.7 | A | B | B | B |

TABLE 4

| | | | | Multilayer Film | | | |
|---|---|---|---|---|---|---|---|
| | | | | Heat of | Heat of | | |
| | | | | Fusion | Fusion | | |
| | | | | Ratio | Ratio | | |
| | Multilayer Film Formation Condition | | | (0° C.-150° | (150° C.-200° | | |
| | Die | | Cooling Roll | C.) | C.) | Appearance | Oxygen |
| | Temperature | Air Gap | Temperature | H1/H2 | H1/H2 | Property | Transmission Rate |
| | ° C. | cm | ° C. | — | — | — | cc/(m² · day · atm) |
| Example 23 | 220 | 7 | 40 | 0.96 | 1.23 | D3 | 1.2 |
| Example 24 | 220 | 7 | 40 | 0.96 | 1.23 | C1 | 1.2 |
| Example 25 | 220 | 7 | 40 | 0.96 | 1.23 | C1 | 1.2 |
| Example 26 | 220 | 7 | 40 | 0.96 | 1.23 | C1 | 1.2 |
| Example 27 | 220 | 7 | 40 | 0.96 | 1.23 | C1 | 1.2 |
| Example 28 | 220 | 7 | 40 | 0.96 | 1.23 | B1 | 1.2 |
| Example 29 | 220 | 7 | 40 | 0.96 | 1.23 | D1 | 1.2 |
| Example 30 | 220 | 7 | 40 | 0.96 | 1.23 | C1 | 1.2 |
| Example 31 | 220 | 7 | 40 | 0.96 | 1.23 | B1 | 1.2 |
| Example 32 | 220 | 7 | 40 | 0.96 | 1.23 | C1 | 1.2 |
| Example 33 | 220 | 7 | 40 | 0.96 | 1.23 | C1 | 2.5 |
| Comparative | 220 | 7 | 80 | 1.03 | 1.37 | C1 | 1.3 |
| Example 1 | | | | | | | |
| Comparative | 220 | 10 | 90 | 1.05 | 1.37 | C1 | 1.2 |
| Example 2 | | | | | | | |
| Comparative | 220 | 7 | 80 | 1.04 | 1.37 | C1 | 1.3 |
| Example 3 | | | | | | | |
| Comparative | 220 | 7 | 40 | 1.02 | 1.23 | B1 | 1.3 |
| Example 4 | | | | | | | |
| Comparative | 220 | 7 | 80 | 1.08 | 1.37 | B1 | 1.2 |
| Example 5 | | | | | | | |
| Comparative | 220 | 7 | 40 | 1.00 | 1.23 | B1 | 1.3 |
| Example 6 | | | | | | | |
| Comparative | 220 | 7 | 80 | 1.10 | 1.37 | B1 | 1.2 |
| Example 7 | | | | | | | |
| Comparative | 220 | 7 | 40 | 1.04 | 1.23 | E1 | 1.3 |
| Example 8 | | | | | | | |
| Comparative | 220 | 7 | 80 | 1.09 | 1.37 | E1 | 1.2 |
| Example 9 | | | | | | | |
| Comparative | 220 | 7 | 80 | 1.03 | 1.37 | C1 | 1.2 |
| Example 10 | | | | | | | |

| | Multilayer Film | | | | Melt Molded Product of | | |
|---|---|---|---|---|---|---|---|
| | Water Vapor | Puncture | Puncture | Drop | Multilayer Film Ground Product | | |
| | Transmission | Elongation at | Strength at | Bag | Hard | | Viscosity |
| | Rate | Break | Break | Test | Spot | Coloration | Stability |
| | g/(m² · day) | mm | N | — | — | — | — |
| Example 23 | 2.7 | 10.5 | 10.4 | A | B | B | B |
| Example 24 | 2.7 | 10.6 | 10.2 | A | B | B | B |
| Example 25 | 2.7 | 10.7 | 10.2 | A | B | B | B |
| Example 26 | 2.8 | 9.5 | 8.7 | B | B | B | B |
| Example 27 | 3.9 | 10.9 | 11.2 | A | B | B | B |
| Example 28 | 3.1 | 10.8 | 10.7 | A | B | B | B |
| Example 29 | 2.7 | 10.7 | 10.2 | A | B | B | B |
| Example 30 | 2.7 | 10.4 | 10.3 | A | B | B | B |
| Example 31 | 2.8 | 9.8 | 9.2 | A | B | B | B |
| Example 32 | 3.2 | 10.8 | 10.3 | A | B | B | B |
| Example 33 | 2.4 | 11.2 | 10.8 | A | A | A | A |
| Comparative | 2.2 | 7.1 | 7.8 | C | B | B | B |
| Example 1 | | | | | | | |
| Comparative | 2.1 | 6.9 | 7.5 | C | B | B | B |
| Example 2 | | | | | | | |
| Comparative | 2.7 | 6.8 | 7.4 | C | B | B | B |
| Example 3 | | | | | | | |
| Comparative | 6.0 | 15.7 | 12.1 | A | B | B | B |
| Example 4 | | | | | | | |
| Comparative | 4.8 | 12.8 | 10.3 | A | B | B | B |
| Example 5 | | | | | | | |
| Comparative | 2.9 | 6.3 | 7.2 | C | B | B | B |
| Example 6 | | | | | | | |
| Comparative | 2.3 | 5.5 | 6.5 | C | B | B | B |
| Example 7 | | | | | | | |
| Comparative | 1.5 | 4.4 | 7.0 | C | B | B | B |
| Example 8 | | | | | | | |
| Comparative | 1.8 | 5.5 | 7.8 | C | B | B | B |
| Example 9 | | | | | | | |
| Comparative | 3.4 | 8.5 | 8.3 | C | B | B | B |
| Example 10 | | | | | | | |

1. A multilayer film, comprising: a barrier layer (A) containing an ethylene-vinyl alcohol copolymer (a) as a main component, the copolymer (a) having an ethylene unit content from 20 to 50 mol % and a degree of saponification of 90 mol % or more; an adhesive layer (B) containing an adhesive resin (b) as a main component; a thermoplastic resin layer (C) containing a polyethylene-based resin (c) as a main component, the resin (c) having a density from 0.941 to 0.980 g/cm³; and a heat seal layer (D) containing an ethylene-α-olefin copolymer resin (d) as a main component, the resin (d) having a density from 0.880 to 0.920 g/cm³, wherein
the multilayer film has the barrier layer (A) between at least a pair of the thermoplastic resin layer (C) and the heat seal layer (D)
and has no layer containing a resin with a melting point of 200° C. or more as a main component and no metal layer with a thickness of 1 μm or more, and
when a temperature is risen from −50° C. to 220° C. at 10° C./min (first temperature rise) and then lowered to −50° C. at 10° C./min and further risen to 220° C. at 10° C./min (second temperature rise) using a differential scanning calorimeter (DSC), a ratio (H1/H2) of a total heat of fusion (H1) from 0° C. to 150° C. during the first temperature rise to a total heat of fusion (H2) from 0° C. to 150° C. during the second temperature rise is from 0.75 to 1.01.

2. The multilayer film according to claim 1, wherein one outermost layer is the thermoplastic resin layer (C) and another outermost layer is the heat seal layer (D).

3. The multilayer film according to claim 1, comprising an adhesive layer (B1) between the barrier layer (A) and the thermoplastic resin layer (C), wherein the adhesive layer (B1) contains an adhesive resin (b1) as a main component and the resin (b1) has an acid value of 0.50 mg KOH/g or more and 2.50 mg KOH/g or less.

4. The multilayer film according to claim 1, wherein the polyethylene-based resin (c) and the ethylene-α-olefin copolymer resin (d) have respective MFRs (190° C., under a load of 2.16 kg) measured in accordance with JIS K7210 (2014) from 0.5 to 2.0 g/10 min.

5. The multilayer film according to claim 1, wherein the ethylene-α-olefin copolymer resin (d) is linear low-density polyethylene obtained by copolymerizing ethylene and an α-olefin with a carbon number of 6 or more.

6. The multilayer film according to claim 1, wherein the heat seal layer (D) contains from 100 to 7000 ppm of a higher fatty acid amide compound (e) with a melting point from 60° C. to 120° C.

7. The multilayer film according to claim 1, wherein the heat seal layer (D) contains from 500 to 5000 ppm of inorganic oxide particles (f) with an average particle diameter from 1 to 30 μm and the inorganic oxide particles (f) are at least one selected from the group consisting of silicon oxide particles and metal oxide particles.

8. The multilayer film according to claim 1, wherein the barrier layer (A) contains from 10 to 200 ppm of polyvalent metal ions (g) that are at least one selected from the group consisting of magnesium ions, calcium ions, and zinc ions.

9. The multilayer film according to claim 1, wherein the barrier layer (A) contains from 10 to 400 ppm of alkali metal ions.

10. The multilayer film according to claim 1, wherein the ethylene-vinyl alcohol copolymer (a) contains an EVOH (a1) having an ethylene unit content of 22 mol % or more and less than 34 mol % and a degree of saponification of 99 mol % or more and an EVOH (a2) having an ethylene unit content of 34 mol % or more and less than 50 mol % and a degree of saponification of 99 mol % or more.

11. The multilayer film according to claim 1, wherein, when the temperature is risen from −50° C. to 220° C. at 10° C./min (the first temperature rise) and then lowered to −50° C. at 10° C./min and further risen to 220° C. at 10° C./min (the second temperature rise) using a differential scanning calorimeter (DSC), a ratio (H1/H2) of a total heat of fusion (H1) from 150° C. to 200° C. during the first temperature rise to a total heat of fusion (H2) from 150° C. to 200° C. during the second temperature rise is from 0.90 to 1.35.

12. The multilayer film according to claim 1, wherein a total thickness of all layers is 200 μm or less and a ratio of a thickness of the barrier layer (A) to the total thickness of all layers is 0.10 or less.

13. The multilayer film according to claim 1, wherein a total thickness of all layers is 200 μm or less and a ratio of a thickness of the thermoplastic resin layer (C) to the total thickness of all layers is 0.20 or more 0.60 or less.

14. The multilayer film according to claim 1, wherein an oxygen transmission rate under conditions of 20° C. and 65% RH is 5 cc/(m²·day·atm) or less, and/or a water vapor transmission rate under conditions of 40° C. and 90% RH is 5 g/(m²·day) or less.

15. (canceled)

16. The multilayer film according to claim 1, wherein an elongation at break is 8.0 mm or more when humidity is conditioned for 24 hours under conditions of 23° C. and 50% RH and then a needle with a tip diameter of 1 mm pierces at a rate of 50 mm/min under the same conditions.

17. The multilayer film according to claim 1, wherein a strength at break is 8.5 N or more when humidity is conditioned for 24 hours under conditions of 23° C. and 50% RH and then a needle with a tip diameter of 1 mm pierces at a rate of 50 mm/min under the same conditions.

18. The multilayer film according to claim 1, wherein the multilayer film has a laminated structure in which the thermoplastic resin layer (C), an adhesive layer (B1), the barrier layer (A), an adhesive layer (B2), and the heat seal layer (D) are laminated in this order.

19. A multilayer structure, wherein the multilayer film according to claim 1 and at least one resin layer (R) containing a thermoplastic resin (h) as a main component are laminated.

20. The multilayer structure according to claim 19, wherein the thermoplastic resin (h) contains a polyethylene resin as a main component.

21. A packaging material, comprising the multilayer film or the multilayer structure according to claim 1.

22-23. (canceled)
